(19) United States
(12) Patent Application Publication
(10) Pub. No.: US 2015/0146294 A1
(43) Pub. Date: May 28, 2015

(54) POLARIZING PLATE, FABRICATION METHOD FOR POLARIZING PLATE, AND IMAGE DISPLAY DEVICE

(71) Applicant: Konica Minolta, Inc., Tokyo (JP)

(72) Inventor: Yasuhiro Watanabe, Tokyo (JP)

(21) Appl. No.: 14/402,335

(22) PCT Filed: May 21, 2013
(86) PCT No.: PCT/JP2013/003228

§ 371 Date: Nov. 20, 2014

(30) Foreign Application Priority Data
May 23, 2012 (JP) 2012-117639

(51) Int. Cl. G02B 5/30; B32B 38/10; B32B 38/00; B32B 37/12; B32B 37/16

(52) U.S. Cl. CPC G02B 5/3025; B32B 37/1284; B32B 37/16; B32B 38/00; B32B 38/10; B32B 2037/1253; B32B 2038/0076; B32B 2305/72; B32B 2307/42; B32B 2307/516; B32B 2310/0837; B32B 2307/4026; B32B 2315/08; B32B 2329/04; B32B 2457/20
USPC 359/487.02; 156/229

(57) ABSTRACT

The purpose of the present invention is to provide a polarization plate the warping and deformation of which can be controlled when the polarization plate, and a display device that contains the polarization plate, is stored under conditions of high heat and humidity, while keeping the display device low profile. This polarization plate has a polarizing element 0.5-10 μm in thickness that contains a dichroic pigment, a glass film, and an adhesion layer that is disposed between the polarizing element and the glass film and that comprises a cured material of an actinic ray curable composition.

### TECHNICAL FIELD

The present invention relates to a polarizing plate, a method of manufacturing a polarizing plate, and an image display device.

### BACKGROUND ART

Recently, the market for liquid crystal displays has been rapidly expanding. In particular, the market for small- and mid-sized mobile devices called smartphones or tablets has been expanding remarkably. Such small- and mid-sized mobile devices have been required to have smaller thickness and lighter weight as well as improved contrast of the displayed image. Accordingly, size reduction of display devices has been studied.

A liquid crystal display device includes, for example, a liquid crystal cell, a first polarizing plate disposed on the viewing side surface, and a second polarizing plate disposed on the backlight side surface. The first polarizing plate has at least a first polarizer and a protective film F1 disposed on the viewing side surface of the first polarizer.

In order to achieve size reduction of display devices, reduction in the thickness of the polarizer has been studied. For example, methods of manufacturing a polarizer have been proposed wherein a polyvinyl alcohol resin is applied to a base material film, followed by uniaxial stretching and dyeing of the coated film (see, e.g., PTL 1 and PTL 2). These methods provide a polarizer having a thickness of 10 μm or less, as opposed to the conventional methods wherein thickness values of polarizers exceed 20 μm.

However, the thickness of the protective film is 60 to 100 μm, and accordingly, in order to reduce the thickness of the polarizer, it is desirable to either reduce the thickness of the protective film as well as the thickness of the polarizer or dispense with the protective film.

Usually, a transparent glass substrate is disposed on the outermost surface on the viewing side of the display device. In other words, the first polarizer constituting the first polarizing plate and the transparent glass substrate are usually laminated on each other through the intermediary of protective film F1.

Accordingly, in order to reduce the thickness of the display device, studies have also been made to dispense with protective film F1; specifically, a method for laminating the first polarizer and the transparent glass substrate on each other without the intermediary of the protective film F1 has also been studied. In addition, the use of an ultrathin film glass for the glass substrate of the display device has also been proposed (see, e.g., PTL 3 and PTL 4). The ultrathin film glass has a thickness of 200 μm or less, and hence can be wound in a roll shape and is satisfactory in productivity.

### CITATION LIST

### Patent Literature

PTL 1
Japanese Patent Application Laid-Open No. 2011-100161
PTL 2
Japanese Patent Application Laid-Open No. 2011-248293
PTL 3
Japanese Patent No. 4326635
PTL 4
Japanese Patent Application Laid-Open No. 2011-121320

### SUMMARY OF INVENTION

### Technical Problem

In order to further reduce the thickness of display devices, the inventors studied lamination of a thin polarizer and a glass substrate (which is disposed on the outermost surface on the viewing side of the display device) without the intermediary of protective film F1.

However, the adhesion of the thin polarizer and the glass substrate to each other through the intermediary of a thermosetting resin tends to cause strain (stress) due to heat to remain in the polarizer because the thermal expansion coefficient difference between the polarizer and the glass substrate is large. Accordingly, the polarizing plate obtained after adhesion tends to warp, and additionally, the storage of the rolled body of the polarizing plate at a high temperature and a high humidity tends to deform the polarizing plate and disadvantageously tends to cause variation in the degree of polarization. Moreover, the storage of a display device including a polarizer having residual strain due to heat at a high temperature and a high humidity disadvantageously tends to distort the polarizer or tends to cause the polarizing plate to warp. Such problems as described above are remarkable in the case where the thickness of the polarizer or the glass substrate is small.

The present invention has been achieved in view of the above-described circumstances pertinent in the art, and an object of the present invention is to provide a polarizing plate capable of sufficiently reducing the thickness of a display device and of limiting the deformation or warping of the polarizing plate when the polarizing plate or the display device including the polarizing plate is stored at a high temperature and a high humidity; a method of manufacturing the polarizing plate; and an image display device including the polarizing plate.

### Solution to Problem

[1] A polarizing plate including:

a polarizer containing a dichroic dye, the polarizing having a thickness of 0.5 to 10 μm;

a glass film; and

an adhesive layer disposed between the polarizer and the glass film, the adhesive layer being formed of a cured product of an actinic radiation-curable composition.

[2] The polarizing plate according to [1], wherein the dichroic dye is localized on one side of the polarizer.

[3] The polarizing plate according to [1] or [2], wherein the actinic radiation-curable composition comprises an ultraviolet absorber.

[4] The polarizing plate according to any one of [1] to [3], wherein an optical transmittance at a wavelength of 380 nm of the adhesive layer formed of the cured product of the actinic radiation-curable composition is 5% or more and 40% or less.

[5] The polarizing plate according to any one of [2] to [4], wherein the adhesive layer formed of the cured product of the actinic radiation-curable composition is disposed on a surface of the polarizer where the dichroic dye is localized.

[6] The polarizing plate according to any one of [1] to [5], wherein a thickness of the glass film is 1 to 200 p.m.

[7] The polarizing plate according to any one of [1] to [6], wherein when a length of the polarizing plate in a width direction is denoted by W, and a length of the polarizing plate in a direction perpendicular to the width direction is denoted by L, L/W is 10 to 3,000, and

the polarizing plate is wound in a roll shape in a direction perpendicular to the width direction of the polarizing plate.

[8] A method of manufacturing the polarizing plate according to any one of [1] to [7], including: A) obtaining a polarizer;

B) laminating the polarizer on a glass film through the intermediary of a layer of an actinic radiation-curable composition, and

C) curing the actinic radiation-curable composition by irradiating the layer of the actinic radiation-curable composition with an actinic radiation,

wherein the step A) of obtaining a polarizer comprises:

1) obtaining a laminate composed of a base material film and a polyvinyl alcohol resin layer by applying a solution containing a polyvinyl alcohol resin on the base material film;

2) uniaxially stretching the laminate; and

3) dyeing the polyvinyl alcohol resin layer of the laminate with a dichroic dye or dyeing the polyvinyl alcohol resin layer after the uniaxial stretching with the dichroic dye.

[9] The method of manufacturing a polarizing plate according to [8], wherein in the step C), the layer of the actinic radiation-curable composition is irradiated with the actinic radiation through the glass film.

[10] The method of manufacturing a polarizing plate according to [8] or [9], wherein in the step B), the polarizer unwound from a rolled body of the polarizer and the glass film unwound from a rolled body of the glass film are laminated on each other through the intermediary of the actinic radiation-curable composition layer.

[11] The method of manufacturing a polarizing plate according to any one of [8] to [10], wherein in the step 3), the polyvinyl alcohol resin layer of the laminate after the uniaxial stretching is dyed with the dichroic dye.

[12] The method of manufacturing a polarizing plate according to any one of [8] to [11], further including, after the step C), removing the base material film laminated on the polarizer.

[13] An image display device including the polarizing plate according to any one of [1] to [6].

### Advantageous Effects of Invention

The present invention can limit deformation or warping of a polarizing plate when the polarizing plate or a display device including the polarizing plate is stored at a high temperature and a high humidity, while capable of reducing the thickness of the display device to a sufficiently small level.

### BRIEF DESCRIPTION OF DRAWINGS

FIG. 1 is a schematic diagram showing an example of a structure of a polarizing plate of the present invention;

FIG. 2 is a schematic diagram showing an example of a structure of a liquid crystal display device of the present invention;

FIG. 3 is a schematic diagram showing an example of a structure of an organic EL display device of the present invention; and

FIG. 4 is a schematic diagram illustrating the antireflection function based on a circularly polarizing plate.

### DESCRIPTION OF EMBODIMENTS

1. Polarizing Plate

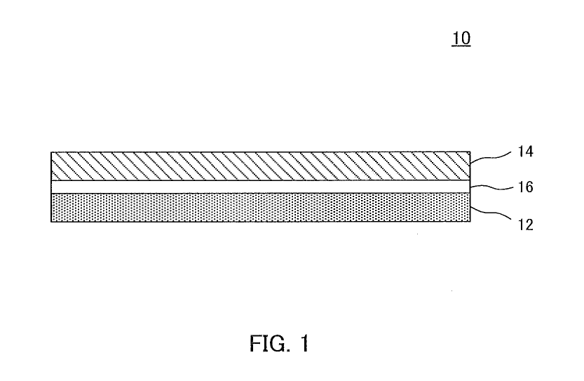

FIG. 1 is a schematic diagram showing an example of a structure of a polarizing plate of the present invention. As shown in FIG. 1, polarizing plate 10 of the present invention includes polarizer 12, glass film 14, and adhesive layer 16 which is disposed between polarizer 12 and glass film 14 and which is formed of a cured product of an actinic radiation-curable composition. Polarizing plate 10 of the present invention is preferably used particularly as the polarizing plate disposed on the viewing side of an image display device.

Polarizer 12

A polarizer is an element which allows only light having a polarized wave plane in a certain direction to pass therethrough. The polarizer is a polarizing film containing a polyvinyl alcohol resin; specifically, the polarizer is a film obtained by uniaxially stretching a film containing a polyvinyl alcohol resin and by dyeing the uniaxially stretched film with a dichroic dye.

Examples of the polyvinyl alcohol resin included in the polarizer include polyvinyl alcohol resins and the derivatives thereof. Examples of the derivatives of polyvinyl alcohol resins include polyvinyl formal, polyvinyl acetal, and polyvinyl alcohol resin derivatives obtained by modifying polyvinyl alcohol resins with, for example, olefins (such as ethylene and propylene), unsaturated carboxylic acids (such as acrylic acid, methacrylic acid and crotonic acid), alkyl esters of unsaturated carboxylic acids, and acrylamide. Among others, for their good polarization properties and durability and less color irregularity, polyvinyl alcohol resins and ethylene-modified polyvinyl alcohol resins are preferable.

The average degree of polymerization of polyvinyl alcohol resin is preferably 100 to 10,000 and more preferably 1,000 to 10,000. If the average degree of polymerization is less than 100, it is difficult to obtain sufficient polarization properties. On the other hand, if the average degree of polymerization exceeds 10,000, the solubility in water tends to decrease. The average degree of saponification of polyvinyl alcohol resin is preferably 80 to 100 mol % and more preferably 98 mol % or more. If the average degree of saponification is less than 80 mol %, it is sometimes difficult to obtain sufficient polarization properties.

Examples of the dichroic dye include iodine and organic dyes. Examples of the organic dye include azo dyes, stilbene dyes, pyrazolone dyes, triphenylmethane dyes, quinoline dyes, oxazine dyes, thiazine dyes, and anthraquinone dyes.

The polarizer may further include, if necessary, additives such as plasticizers and surfactants. Examples of the plasticizers include polyols and the condensates thereof, and specific examples of polyols and the condensates thereof include glycerin, diglycerin, triglycerin, ethylene glycol, propylene glycol, and polyethylene glycol. The content of these additives can be set at, for example, 20 wt % or less based on the polyvinyl alcohol resin.

The dichroic dye in the polarizer is preferably localized on one side of the polarizer in order to obtain a high degree of polarization even with a thin film polarizer. The layer thickness of the dichroic dye localized in the polarizer can be set at 80% or less of the thickness of the polarizer.

A polarizer containing a dichroic dye localized on one side can be manufactured for example by a method in which a polarizer protected on one side with a masking film or base material film is immersed in a solution containing the dichroic dye, or a method in which a solution containing the dichroic dye is applied only to one surface of a polarizer with, for example, a lip coater.

Whether or not the dichroic dye is localized in the thickness direction of the polarizer can be confirmed by observing a cross section of the polarizer with a scanning electron microscope (SEM).

An adhesive layer formed of a cured product of an actinic radiation-curable composition is preferably laminated onto a surface of the polarizer where the dichroic dye is localized. Covering the surface of the polarizer where the dichroic dye is localized with the adhesive layer formed of a cured product of an actinic radiation-curable composition makes it possible to make the surface of the polarizer on the side where the dichroic dye is localized less susceptible to heat or humidity from the external environment, and thus the orientation unevenness of the dichroic dye can be limited.

The thickness of the polarizer is not particularly limited, but is preferably 30 μm or less, and more preferably 10 μm or less in order to sufficiently reduce the thickness of the polarizing plate. On the other hand, the thickness of the polarizer is preferably 0.5 μm or more and more preferably 3 μm or more, in order to ensure at least a certain level of strength or dyeing performance.

Glass Film 14

The material of the glass film is soda lime glass, silicate glass or the like, preferably silicate glass, and more preferably silica glass or borosilicate glass.

The glass that constitutes the glass film is preferably an alkali-free glass substantially containing no alkali component, and is specifically preferably a glass having a content of the alkali component of 1,000 ppm or less. The content of the alkali component in the glass film is preferably 500 ppm or less and more preferably 300 ppm or less. This is because the glass film containing an alkali component undergoes the occurrence of the cation exchange on the film surface and a phenomenon of soda blow tends to occur, and consequently, the density of the film surface layer tends to decrease and the glass film tends to be damaged.

The thickness of the glass film is preferably 300 μm or less, and in order to ensure a certain strength and to allow the glass film to be easily wound in a roll shape by imparting flexibility, the thickness of the glass film is preferably 1 to 200 μm, more preferably 1 to 100 μm and furthermore preferably 5 to 50 μm. If the thickness of the glass film exceeds 300 μm, no sufficient flexibility can be imparted to the glass film and it is difficult to wind the glass film into a roll shape. On the other hand, if the thickness of the glass film is less than 1 μm, the strength of the glass film is insufficient, and the glass film tends to be broken.

The glass film can be formed by any methods known in the art, such as float method, down-draw method or over-flow down-draw method. Among others, the over-flow down-draw method is preferable because at the time of forming the glass film, the surface of the glass film is not brought into contact with the forming member, and the surface of the glass film to be obtained is not easily scratched.

Adhesive Layer 16 Formed of Cured Product of Actinic Radiation-Curable Composition

The adhesive layer formed of a cured product of an actinic radiation-curable composition has a function of bonding the polarizer and the glass film to each other. As described below, the actinic radiation-curable composition contains an actinic radiation-curable compound. The actinic radiation-curable compound is preferably an ultraviolet curable compound.

The ultraviolet curable compound may be either a cationic polymerizable compound or a radically polymerizable compound. The ultraviolet curable compound can be a monomer, an oligomer, a polymer or a mixture thereof.

In order to enhance the adhesion of the cured product to the adherend, the cationic polymerizable compound is preferably an epoxy compound, and more preferably an epoxy compound which is liquid at normal temperature because of good application properties.

The epoxy compound which is liquid at normal temperature can be an aliphatic epoxy compound, an alicyclic epoxy compound or an aromatic epoxy compound. Among others, an alicyclic epoxy compound is preferable in order to reduce the viscosity of the epoxy compound and to obtain a high curability.

Examples of the alicyclic epoxy compound include the following:

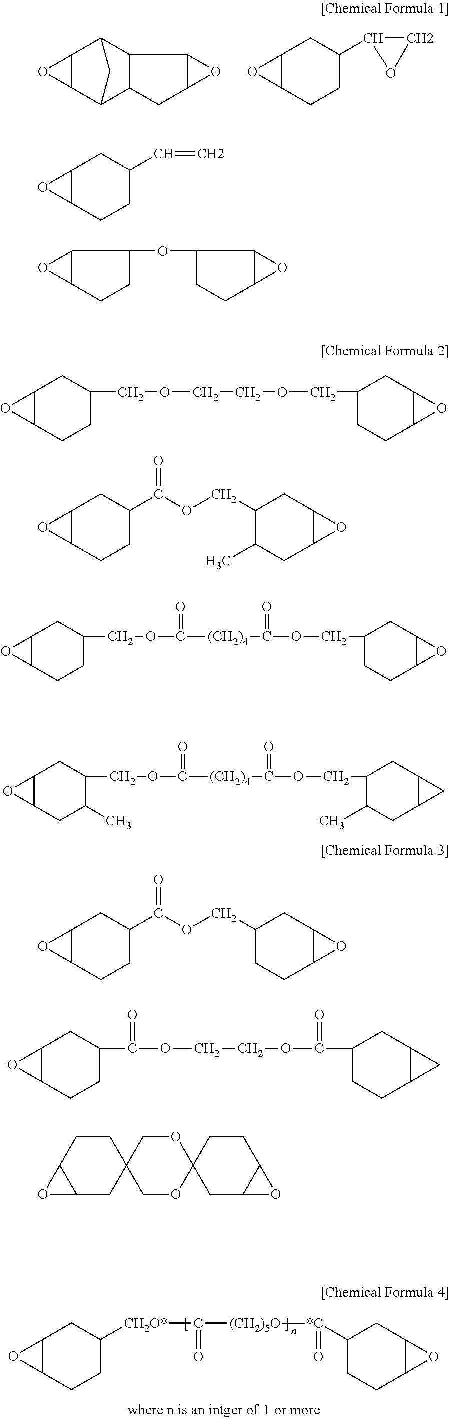

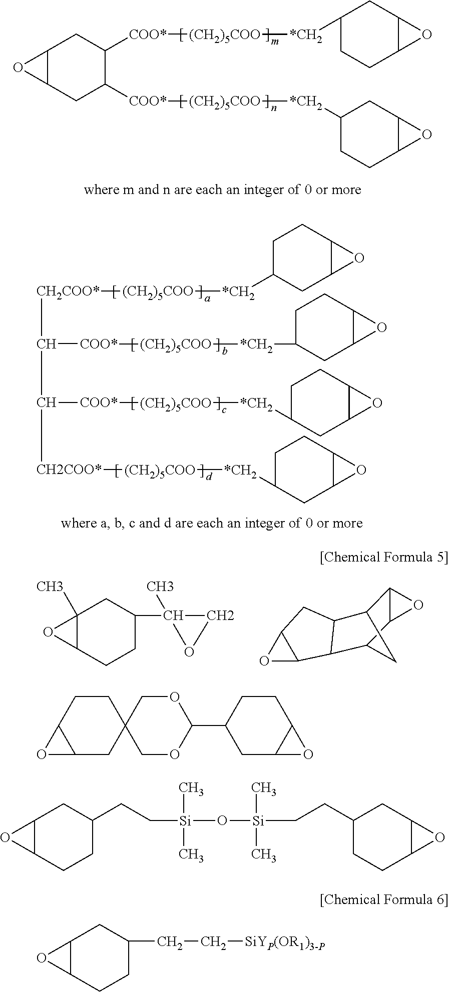

wherein Y represents a C₁₋₄ alkyl group optionally substituted with halogen atom; R₁ represents a C₁₋₄ alkyl group; and P is 0 or 1

Examples of the aliphatic epoxy compound include polyethylene glycol diglycidyl ether, polypropylene glycol diglycidyl ether, neopentylglycol diglycidyl ether, trimethylolpropane triglycidyl ether, and alkoxysilane containing the following glycidoxy group:

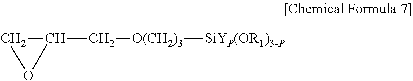

where Y represents a C₁₋₄ alkyl group optionally substituted with halogen atom; R₁ represents a C₁₋₄ alkyl group; and P is 0 or 1

Examples of the aromatic epoxy compound include cresol novolac epoxy resin, bisphenol A epoxy resin and bisphenol F epoxy resin.

The epoxy compound which is liquid at normal temperature may be a single compound or a mixture of two or more compounds. In order to enhance the curability, the content of the alicyclic epoxy compound in the actinic radiation-curable composition is preferably 30% or more based on the total amount of the actinic radiation-curable compound.

The radically polymerizable compound is preferably a radically polymerizable compound having an ethylenically unsaturated bond. The radically polymerizable compound may be a single compound or a mixture of two or more compounds.

Examples of the radically polymerizable compound having an ethylenically unsaturated bond include unsaturated carboxylic acid ester compounds. Examples of the unsaturated carboxylic acid in the unsaturated carboxylic acid ester compound include (meth)acrylic acid, itaconic acid, crotonic acid, isocrotonic acid and maleic acid. The unsaturated carboxylic acid ester compound is preferably a (meth)acrylate compound.

Examples of the (meth)acrylate compound include monofunctional (meth)acrylate compounds such as methyl(meth)acrylate, ethyl(meth)acrylate, isoamyl(meth)acrylate, stearyl(meth)acrylate, lauryl(meth)acrylate, octyl(meth)acrylate, decyl(meth)acrylate, butoxyethyl(meth)acrylate and t-butylcyclohexyl(meth)acrylate; bifunctional (meth)acrylate compounds such as triethylene glycol di(meth)acrylate, tetraethylene glycol di(meth)acrylate, polyethylene glycol di(meth)acrylate, tripropylene glycol di(meth)acrylate, polypropylene glycol di(meth)acrylate, 1,4-butanediol di(meth)acrylate and 1,6-hexanediol di(meth)acrylate; and tri- or more functional (meth)acrylate compounds such as trimethylolpropane tri(meth)acrylate, pentaerythritol tri(meth)acrylate, pentaerythritol tetra(meth)acrylate, dipentaerythritol hexa(meth)acrylate, ditrimethylolpropane tetra(meth)acrylate and pentaerythritol ethoxy tetra(meth)acrylate. In order to enhance the curability, among others, bifunctional or tri- or more functional (meth)acrylate compounds are preferable.

The (meth)acrylate compounds may further include a group(s) such as a glycidyl group. Examples of the glycidyl group-containing (meth)acrylate compound include glycidyl(meth)acrylate.

The actinic radiation-curable composition may further contain, if necessary, other resins such as petroleum resins, polyester resins, polyurethane resins, acrylic resins, and polyether resins, and ultraviolet absorbers. In order to enhance the adhesion between the glass film and the polarizer, the actinic radiation-curable composition, namely, the adhesive layer formed of a cured product of the actinic radiation-curable composition preferably further contains, among others, an ultraviolet absorber.

The ultraviolet absorber is not particularly limited, and can be, for example, an oxybenzophenone compound, benzotriazole compound, a salicylic acid ester compound, a benzophenone compound, a cyanoacrylate compound, a triazine compound, a nickel complex salt compound and an inorganic powder. Among others, a benzotriazole compound, a benzophenone compound and a triazine compound are preferable, and a benzotriazole compound and a benzophenone compound are more preferable.

Specific examples of the ultraviolet absorber include 5-chloro-2-(3,5-di-sec-butyl-2-hydroxyphenyl)-2H-benzotriazole, (2-2H-benzotriazole-2-yl)-6-(linear chain and side chain dodecyl)-4-methylphenol, 2-(2H-benzotriazole-2-yl)-6-(1-methyl-1-phenylethyl)-4-(1,1,3,3-tetramethylbutyl)phenol, 2-hydroxy-4-benzyloxybenzophenone and 2,4-benzyloxybenzophenone. Preferable examples of the commercially available ultraviolet absorber include Tinuvins (all manufactured by BASF Japan Ltd.) such as Tinuvin 109, Tinuvin 171, Tinuvin 234, Tinuvin 326, Tinuvin 327, Tinuvin 328 and Tinuvin 928.

Additionally, disk-shaped compounds such as 1,3,5-triazine ring-containing compounds and polymer ultraviolet absorbers are preferably used; specifically, for example, the polymer-type ultraviolet absorbers described in Japanese Patent Application Laid-Open No. 06-148430 are preferably used.

The ultraviolet absorber may be a single ultraviolet absorber or a mixture of two or more ultraviolet absorbers.

The content of the ultraviolet absorber can be set depending on, for example, the type and use conditions of the ultraviolet absorber, and is preferably 0.5 to 15 mass % and more preferably 0.6 to 10 mass % based on the adhesive layer formed of a cured product of the actinic radiation-curable composition. If the content of the ultraviolet absorber is less than 0.5 mass %, the actinic radiation-curable composition in the vicinity of the polarizer is excessively cured and the modulus of elasticity of the obtained adhesive layer tends to be too high. Consequently, the adhesive layer sometimes cannot sufficiently absorb the defoimation of the polarizer at a high temperature and a high humidity. On the other hand, if the content of the ultraviolet absorber exceeds 15 mass %, the actinic radiation-curable composition in the vicinity of the polarizer tends to be cured insufficiently, and a sufficient adhesiveness to the polarizer cannot be easily obtained.

The optical transmittance of the adhesive layer formed of a cured product of the actinic radiation-curable composition at a wavelength of 380 nm is preferably 5 to 40% and more preferably 5 to 35%. An adhesive layer that exhibits an optical transmittance of less than 5% contains an excessive amount of ultraviolet absorber, and hence frequently the curing of the actinic radiation-curable composition in the vicinity of the polarizer is insufficient. On the other hand, an adhesive layer that exhibits an optical transmittance exceeding 40% contains almost no ultraviolet absorber, hence the modulus of elasticity of the adhesive layer in the vicinity of the polarizer is too high, and during storage at a high temperature and a high humidity, the stress due to the contraction of the polarizer may not be easily absorbed. The optical transmittance of the adhesive layer formed of a cured product of the actinic radiation-curable composition can be controlled for example by the content and the type of the ultraviolet absorber.

The optical transmittance of the adhesive layer formed of the actinic radiation-curable composition at a wavelength of 380 nm can be measured with a spectrophotometer (ultraviolet-visible-near infrared spectrophotometer V-670, manufactured by JASCO Corp.).

The thickness of the adhesive layer fowled of a cured product of the actinic radiation-curable composition is not particularly limited, but is preferably 1 to 30 μm and more preferably 3 to 20 μm. If the thickness of the adhesive layer formed of a cured product of the actinic radiation-curable composition is less than 1 μm, the adhesion between the adhesive layer and the polarizer or the glass film may be insufficient. On the other hand, if the thickness of the adhesive layer exceeds 30 μm, the polarizing plate becomes too thick.

Protective Film

The polarizing plate of the present invention may further include, if necessary, a protective film on the surface opposite to the adhesive layer faulted of a cured product of the actinic radiation-curable compound.

The protective film contains a thermoplastic resin such as a cellulose ester, a cyclic olefin resin, or a (meth)acrylic resin. The protective film preferably contains, among others, a cellulose ester because of good adhesion to the polarizer.

Cellulose Ester

Cellulose ester is a compound obtained by esterifying the hydroxyl groups of cellulose with an aliphatic carboxylic acid or an aromatic carboxylic acid.

The acyl groups included in the cellulose ester are aliphatic acyl groups or aromatic acyl groups, and are preferably aliphatic acyl groups. Among others, the number of the carbon atoms in the aliphatic acyl group is preferably 2 to 6 and more preferably 2 to 4. Examples of the C₂₋₄ aliphatic acyl group include acetyl group, propionyl group, and butanoyl group, and acetyl group and propionyl group are more preferable.

The total degree of acyl substitution of the cellulose ester is 2.0 to 3.0, and is preferably 2.0 to 2.6 in order to obtain a high degree of retardation by stretching.

The degree of acyl substitution of the cellulose ester can be measured according to ASTM-D817-96.

Examples of the cellulose ester include cellulose acetate, cellulose propionate, cellulose butyrate, cellulose acetate propionate and cellulose acetate butyrate, and preferably include cellulose acetate and cellulose acetate propionate.

The degree of acyl substitution of the cellulose ester is preferably 2.0 to 2.6 in order to develop retardation. The degree of acyl substitution other than acetyl group contained in the cellulose ester is preferably 1.0 or less.

The number average molecular weight of the cellulose ester is preferably 3.0×10⁴ or more and less than 2.0×10⁵ and more preferably 4.5×10⁴ or more and less than 1.5×10⁵ in order to obtain a film having high mechanical strength. The weight average molecular weight of the cellulose ester is preferably 1.2×10⁵ or more and less than 2.5×10⁵ and more preferably 1.5×10⁵ or more and less than 2.0×10⁵.

The molecular weight distribution (weight average molecular weight Mw/number average molecular weight Mn) of the cellulose ester is preferably 1.0 to 4.5.

The number average molecular weight Mn and the weight average molecular weight Mw of the cellulose ester can be measured by gel permeation chromatography (GPC). The measurement conditions are as follows.

Solvent: Methylene chloride

Columns: Shodex K806, K805, K803G (manufactured by Showa Denko K.K.);

three columns are connected to be used.

Column temperature: 25° C.

Sample concentration: 0.1 mass %

Detector: RI Model 504 (manufactured by GL Sciences Inc.)

Pump: L6000 (manufactured by Hitachi, Ltd.)

Flow rate: 1.0 ml/min

Calibration curve: A calibration curve based on 13 samples of Standard polystyrene STK standard polystyrene (manufactured by Tosoh Corp.) of Mw=1.0×10⁶ to 5.0×10² is used. It is preferable to select 13 samples at nearly equal intervals

The protective film may further contain, if necessary, additives such as plasticizers, ultraviolet absorbers, antioxidants, light stabilizers, retardation regulators, antistatic agents, release agents, and matte agents (fine particles).

The thickness of the protective film is preferably 10 to 200 μm, more preferably 10 to 100 μm and furthermore preferably 15 to 45 μm. If the thickness of the film exceeds 200 μm, the variation in retardation tends to become large due to heat or humidity. On the other hand, if the thickness of the film is less than 10 μm, a sufficient film strength cannot be easily obtained.

The retardation in the in-plane direction or thickness direction of the protective film is set according to the display type or required optical performance of the liquid crystal cell. For example, in order to adjust the retardation of an IPS-type liquid crystal cell, the retardation Ro in the in-plane direction and the retardation Rth in the thickness direction of the protective film, measured at a wavelength of 590 nm in the environment of 23° C. and 55% RH are each preferably −3 nm or more and 3 nm or less and more preferably −2 nm or more and 2 nm or less.

Retardations Ro and Rth are defined by the following formulas, respectively:

Ro=(nx−ny)×d Formula (I)

Rth={(nx+ny)/2−nz}×d Formula (II)

(where nx: the refractive index in the slow axis direction x in the film plane, ny: the refractive index in the y direction perpendicular to the slow axis direction x in the film plane, nz: the refractive index in the thickness direction z of the film, d: the thickness of the film (nm))

Retardations Ro and Rth can be measured by, for example, the following method.

1) The film is moisture-conditioned at 23° C. and 55% RH. The average refractive index of the moisture conditioned film is measured with, for example, an Abbe's refractometer.

2) Ro in the case where a light beam of a measurement wavelength of 590 nm is made incident on the moisture conditioned film in parallel to the normal of the film surface is measured with the KOBRA21ADH, manufactured by Oji Scientific Instruments Co., Ltd.

3) The slow axis in the film plane is taken as the inclination axis (rotation axis), and the retardation value R(θ) in the case where a light beam of a measurement wavelength of 590 nm is made incident at an angle (incident angle (θ)) of θ in relation to the normal of the film surface is measured with the KOBRA21ADH. The measurement of the retardation value R(θ) can be performed in a range from 0° to 50° at 6 points with an interval of 10°. The slow axis in the film plane can be verified with the KOBRA21ADH.

4) From the measured Ro and R(θ), and the foregoing average refractive index and the film thickness, with the KOBRA21ADH, nx, ny and nz are calculated and the Rth at the measurement wavelength of 590 nm is calculated. The measurement of the retardation can be performed under the conditions of 23° C. and 55% RH.

The internal haze of the film measured according to JIS K-7136 is preferably 0.01 to 0.1. The visible transmittance of the film is preferably 90% or more and more preferably 93% or more.

2. Method of Manufacturing Polarizing Plate of Present Invention

The polarizing plate of the present invention can be manufactured by: step A) of obtaining a polarizer having a thickness of 0.5 to 10 μm, step B) of laminating the polarizer on a glass film through the intermediary of an actinic radiation-curable composition layer, and step C) of curing the actinic radiation-curable composition by irradiating the actinic radiation-curable composition layer with an actinic radiation.

A) Step of Obtaining Polarizer

The step of obtaining the polarizer includes at least: the step 1) of obtaining a laminate composed of a base material film and a polyvinyl alcohol resin layer by applying a solution containing the polyvinyl alcohol resin on the base material film; the step 2) of uniaxially stretching the laminate; and the step 3) of dyeing the polyvinyl alcohol resin layer of the laminate with a dichroic dye or dyeing the polyvinyl alcohol resin layer after the uniaxial stretching with the dichroic dye.

1) Application Step

By applying a solution containing a polyvinyl alcohol resin to one surface of the base material film, and then drying the applied solution, the laminate composed of the base material film and the polyvinyl alcohol resin layer can be obtained. Thus, the polyvinyl alcohol resin layer can be formed which is thin and uniform in thickness.

The solution containing the polyvinyl alcohol resin may be a solution obtained by dissolving a powder of the polyvinyl alcohol resin in a good solvent. The polyvinyl alcohol resin is the same as that described above.

The thickness of the polyvinyl alcohol resin layer in the laminate is, for example, preferably 3 to 30 μm and more preferably 5 to 20 μm. If the thickness of the polyvinyl alcohol resin layer is less than 3 μm, the polyvinyl alcohol resin layer after stretching becomes too thin, and the dyeing performance tends to be reduced. On the other hand, if the thickness of the polyvinyl alcohol resin layer exceeds 30 μm, the polarizing plate tends to be thick.

The application of the solution containing the polyvinyl alcohol resin can be performed by any of the methods known in the art, such as roll coating method such as wire bar coating method, spin coating method, screen coating method, dipping method, or spray method. The drying temperature can be set at, for example, 50 to 200° C.

The material of the base material film is not particularly limited, and is preferably a thermoplastic resin high in properties such as mechanical strength, stretchability and thermal stability. Examples of such a thermoplastic resin include: cellulose ester resins such as cellulose ester; polyester resins such as polyethylene terephthalate; and polyolefin resins such as polyethylene and polypropylene.

The glass transition temperature (Tg) of the base material film may fall within a range suitable for stretching, and can be, for example, 60° C. or higher and 250° C. or lower.

The thickness of the base material film is not particularly limited, and is preferably 1 to 500 μm, more preferably 1 to 300 μm and furthermore preferably 5 to 200 μm, for example, in order to obtain a certain film strength or higher.

2) Stretching Step

The laminate composed of the base material film and the polyvinyl alcohol resin layer is uniaxially stretched. The stretching magnification factor of the laminate can be set according to the demanded polarization properties, and is preferably 2 to 7 and more preferably 5 to 7. If the stretching magnification factor is less than 2, the molecular chains of the polyvinyl alcohol resin are not sufficiently oriented, and hence the degree of polarization of the obtained polarizer tends to be insufficient. On the other hand, if the stretching magnification factor exceeds 7, the laminate tends to be broken at the time of stretching, and additionally, the thickness of the laminate after stretching tends to be smaller than necessary.

The uniaxial stretching may be performed in width direction (TD direction), conveying direction (MD direction) or oblique direction, and is preferably performed in conveying direction (MD direction). The method for uniaxially stretching in conveying direction (MD direction) can be a roll-to-roll stretching method, a compression stretching method, or a stretching method using a tenter. The uniaxial stretching may be a free-end stretching or a fixed-end stretching, and is preferably a free-end stretching.

The stretching treatment may be performed by either wet process or dry process, and is preferably performed by dry process because the dry process allows the stretching temperature of the laminate to be set in a wider range.

The stretching temperature is preferably set in the vicinity of Tg of the base material film; specifically, the stretching temperature is preferably in a range from (Tg of the base material film −30° C.) to (Tg of the base material film +5° C.) and more preferably in a range from (Tg of the base material film −25° C.) to (Tg of the base material film). If the stretching temperature is lower than (Tg of the base material film −30° C.), the stretching with such a high magnification factor as described above is made difficult. On the other hand, if the stretching temperature is higher than (Tg of the base material film +5° C.), the fluidity of the base material film is too large, and the stretching tends to be difficult. The stretching temperature falls within the above-described range, and is more preferably 120° C. or higher.

3) Dyeing Step

The step of dyeing the polyvinyl alcohol resin layer with a dichroic dye can be performed simultaneously with the stretching step, or before or after the stretching step; the dyeing step is preferably performed after the stretching step in order to satisfactorily orient the dichroic dye.

The dyeing of the polyvinyl alcohol resin layer can be performed by immersing the laminate after uniaxial stretching in a solution (dyeing solution) containing the dichroic dye.

The dyeing solution can be a solution prepared by dissolving the foregoing dichroic dye in a solvent. The solvent of the dyeing solution may be generally water, or may be a mixture composed of water and an organic solvent compatible with water. The concentration of the dichroic dye in the dyeing solution is preferably 0.01 to 10 wt %, more preferably 0.02 to 7 wt % and particularly preferably 0.025 to 5 wt %.

The dyeing solution containing iodine as the dichroic dye preferably further contains an iodide in order to further improve the dyeing efficiency. Examples of the iodide include potassium iodide, lithium iodide, sodium iodide, zinc iodide, aluminum iodide, lead iodide, copper iodide, barium iodide, calcium iodide, tin iodide, and titanium iodide, with potassium iodide being preferable.

The concentration of the iodide in the dyeing solution is preferably 0.01 to 10 wt %. When the iodide is potassium iodide, the content ratio (mass) of iodine to potassium iodide is preferably in a range from 1:5 to 1:100 and more preferably in a range from 1:6 to 1:80.

The immersion time of the laminate after uniaxial stretching in the dyeing solution is not particularly limited, and is preferably in a range from 15 seconds to 15 minutes and more preferably in a range from 1 minute to 3 minutes. The temperature of the dyeing solution is preferably in a range from 10 to 60° C. and more preferably in a range from 20 to 40° C.

After the dyeing step, if necessary, a cross-linking step 4) may further be performed in order to facilitate the fixation of the dyeing dichroic dye in the polyvinyl alcohol resin layer.

4) Cross-Linking Step

The cross-linking step can be performed, for example, by immersing the laminate dyed in the dyeing step in a cross-linking agent-containing solution (cross-linking solution). As the cross-linking agent, any of the cross-linking agents known in the art can be used; examples of such a cross-linking agent include boron compounds such as boric acid and borax, and glyoxal and glutaraldehyde.

The cross-linking solution may be a solution prepared by dissolving a cross-linking agent in a solvent. As described above, the solvent may be water, or a mixture composed of water and an organic solvent compatible with water. The concentration of the cross-linking agent in the cross-linking solution is preferably in a range from 1 to 10 wt % and more preferably in a range from 2 to 6 wt %.

The cross-linking solution preferably further contains an iodide in order to make uniform the polarization properties in the plane of the resulting polarizer. The iodide can be the same as that described above. The concentration of the iodide in the cross-linking solution is preferably 0.05 to 15 wt % and more preferably 0.5 to 8 wt %.

The immersion time of the dyed laminate in the cross-linking solution is preferably 15 seconds to 20 minutes and more preferably 30 seconds to 15 minutes. The temperature of the cross-linking solution is preferably in a range from 10 to 80° C.

The cross-linking step may be performed simultaneously with the dyeing step by adding the cross-linking agent in the dyeing solution. The cross-linking step may also be performed simultaneously with the stretching step.

The laminate thus obtained is preferably washed and then dried. The washing can be performed by immersing the obtained laminate in pure water such as ion-exchanged water or distilled water. The water washing temperature can be set usually in a range from 3 to 50° C., and preferably in a range from 4 to 20° C. The immersion time can be set at 2 to 300 seconds and preferably at 5 to 240 seconds.

In the manner described above, the polyvinyl alcohol resin layer in the application step is converted into the polarizer at least through the stretching step and the dyeing step. The polarizer is an optical element in which the dichroic dye is uniaxially oriented in the stretching direction. The orientation state of the dichroic dye in the polarizer can be measured with, for example, a commercially available automatic birefringence analyzer (KOBAR-WPR, manufactured by Oji Scientific Instruments Ltd.).

The polarizing plate obtained in the present step may be a rolled body wound in a direction perpendicular to the width direction.

B) Step of Laminating Polarizer on Glass Film

The polarizer of the laminate obtained as described above is laminated on a glass film through the intermediary of the actinic radiation-curable composition layer. The glass film described above can be used.

The actinic radiation-curable composition layer can be obtained by applying the actinic radiation-curable composition to the polarizer or the glass film and then drying the applied composition. The actinic radiation-curable composition layer may be disposed on the surface of the polarizer dyed with the dichroic dye or may be disposed on the surface not dyed with the dichroic dye. In order to reduce the orientation unevenness of the dichroic dye at a high temperature and a high humidity, the actinic radiation-curable composition layer is preferably disposed on the surface of the polarizer dyed with the dichroic dye.

The actinic radiation-curable composition contains the foregoing actinic radiation-curable compound and a photopolymerization initiator, and may further contain, if necessary, additives such as ultraviolet absorbers, surfactants, coupling agents, leveling agents, and antifoaming agents.

The photopolymerization initiator is selected according to the type of the actinic radiation-curable compound, and can be a photocationic polymerization initiator or a photoradical polymerization initiator.

Examples of the photocationic polymerization initiator include: aryl diazonium salts such as PP-33 (manufactured by Asahi Denka Kogyo Co., Ltd.); aryl sulfonium salts such as FC-509 (manufactured by 3M Ltd.), UVE1014 (manufactured by General Electric Co.), UVI-6974, UVI-6970, UVI-6990 and UVI-6950 (manufactured by Union Carbide Corp.), and SP-170 and SP-150 (manufactured by Asahi Denka Kogyo Co., Ltd.); aryl iodonium salts; and allene-ion complexes such as CG-24-61 (manufactured by Ciba-Geigy GmbH).

The photoradical polymerization initiator polymerizes the foregoing radically polymerizable compound, and is classified into an intramolecular bond cleavage type and an intramolecular hydrogen abstraction type. Examples of the intramolecular bond cleavage-type photoradical polymerization initiator include: acetophenone-based compounds such as 1-hydroxy-cyclohexyl-phenyl-ketone, diethoxyacetophenone and 2-hydroxy-2-methyl-1-phenylpropane-1-one; benzoins such as benzoin and benzoin methyl ether; and acylphosphine oxide-based compounds such as 2,4,6-trimethylbenzoin diphenylphosphine oxide.

Examples of the intramolecular hydrogen abstraction-type photoradical polymerization initiator include: benzophenone-based compounds such as benzophenone and o-benzoyl benzoic acid methyl-4-phenylbenzophenone; thioxanthone-based compounds such as 2-isopropylthioxanthone and 2,4-dimethylthioxanthone; and aminobenzophenone-based compounds such as Michler's ketone and 4,4′-diethylaminobenzophenone.

The content of the photopolymerization initiator in the actinic radiation-curable composition is preferably 0.5 to 30 mass % based on the actinic radiation-curable compound.

The surfactant can be contained for the purpose of facilitating the leveling of the actinic radiation-curable composition on the polarizer or the glass film. The surfactant is not particularly limited, and is preferably a silicone surfactant and is more preferably a polyether-modified silicone surfactant. Examples of commercially available silicone surfactants include: L-series (such as L7001, L-7006, L-7604 and L-9000), Y series and FZ series (FZ-2203, FZ-2206 and FZ-2207) manufactured by Nippon Unicar Co., Ltd.

The content of the surfactant in the actinic radiation-curable composition can be set at about 0.01 to 3 mass % based on the solid content in the composition.

The coupling agent can be included for the purpose of enhancing the adhesiveness between the adhesive layer formed of the cured product of the actinic radiation-curable composition and the glass film. Examples of the coupling agent include silane coupling agents such as vinyltrimethoxysilane and γ-glycidoxypropyltrimethoxysilane.

The content of the coupling agent in the actinic radiation-curable composition can be set at about 0.2 to 2.0 mass %.

The viscosity of the actinic radiation-curable composition at 25° C. is preferably in a range from 20 to 2,000 mPas because of good workability and high transparency of the cured product.

The application of the actinic radiation-curable composition may be performed either on the glass film or on the polarizer, and is preferably performed on the glass film because of easiness in forming a uniform coating film. The application method of the composition containing the actinic radiation-curable compound is not particularly limited, and can be, for example, roll coating method such as wire bar coating method, or spin coating method.

The thickness of the actinic radiation-curable composition layer is set such that the thickness after curing falls within the foregoing range, and can be, for example, about 0.5 to 50 μm.

The content of the ultraviolet absorber in the actinic radiation-curable composition layer is preferably set such that the content of the ultraviolet absorber in the adhesive layer obtained after curing falls within the foregoing range. If the content of the ultraviolet absorber is too large, the optical transmittance of the adhesive layer obtained after curing tends to be less than 5%. Accordingly, when the actinic radiation-curable composition layer is irradiated with actinic radiation through the glass film, the actinic radiation does not sufficiently reach the actinic radiation-curable composition as far as the vicinity of the polarizer, and hence the curing of the actinic radiation-curable composition tends to be insufficient. On the other hand, if the content of the ultraviolet absorber is too small, the optical transmittance of the adhesive layer obtained after curing tends to exceed 40%. Accordingly, when the actinic radiation-curable composition layer is irradiated with actinic radiation through the glass film, the actinic radiation-curable composition in the vicinity of the polarizer is cured excessively. Consequently, the modulus of elasticity of the adhesive layer formed of the cured product of the actinic radiation-curable composition in the vicinity of the polarizer becomes too high, and during storage at a high temperature and a high humidity, the stress due to the contraction of the polarizer may not be easily absorbed.

In the present step, the polarizer unwound from the rolled body of the polarizer and the glass film unwound from the rolled body of the glass film are preferably laminated on each other through the intermediary of the actinic radiation-curable composition layer.

C) Step of Curing Actinic Radiation-Curable Composition Layer

By irradiating the actinic radiation-curable composition layer with an actinic radiation, the actinic radiation-curable composition is cured. In this way, an adhesive layer formed of a cured product of the actinic radiation-curable composition is obtained.

The actinic radiation can be, for example, visible ray, ultraviolet ray, X-ray or electron beam, and is commonly ultraviolet ray. The light source of the actinic radiation is not particularly limited, and can be a light source emitting light of 200 to 400 nm wavelength, such as a high-pressure mercury lamp, an ultrahigh-pressure mercury lamp, a metal halide lamp, a xenon lamp, or a carbon arc lamp.

The actinic radiation-curable composition layer may be irradiated with actinic radiation through the glass film or the polarizer. When the actinic radiation-curable composition contains an ultraviolet absorber, the actinic radiation-curable composition layer is preferably irradiated with actinic radiation through the glass film. This is because the degree of curing of the actinic radiation-curable composition in the vicinity of the polarizer can be made low.

The irradiation intensity of the actinic radiation depends on the composition of the actinic radiation-curable composition layer, and the irradiation intensity in the wavelength region capable of activating the photocationic polymerization initiator is preferably in a range from 1 to 3,000 mW/cm².

The irradiation time of the actinic radiation is preferably set, for example, such that the accumulated light amount represented by the product of the irradiation intensity and the irradiation time is in a range from 10 to 5,000 mJ/cm². If the accumulated light amount is less than 10 mJ/cm², such an accumulated light amount is not sufficient to activate the photocationic polymerization initiator, and the actinic radiation-curable composition sometimes cannot be sufficiently cured.

D) Step of Releasing Base Material Film

From the laminate having the configuration base material film/polarizer/adhesive layer formed of a cured product of the actinic radiation-curable composition/glass film, the base material film is removed. Then, a polarizing plate can be obtained by attaching, if necessary, a protective film to the surface of the polarizer, on the side from which the base material film has been removed. The protective film is the same as that described above.

The obtained polarizing plate may be stored as a rolled body wound in the direction perpendicular to the width direction. With regard to the polarizing plate in the rolled body, when the length of the polarizing plate in the width direction is denoted by W, and the length of the polarizing plate in the direction perpendicular to the width direction is denoted by L, L/W is preferably in a range from 10 to 3,000, because of good productivity.

As described above, in the present invention, the polarizer and the glass film are laminated on each other without the intermediary of protective film F1. Thus, a thinner polarizing plate can be obtained as compared with a conventional method wherein a polarizer and a glass substrate are laminated on each other through the intermediary protective film F1. In the present invention, a thin film polarizer obtained by application methods is used, and hence a further thinner polarizing plate can be obtained as compared with a conventional method using a thick film polarizer.

On the other hand, when a thin film polarizer and a glass film are bonded to each other through the intermediary of a thermally curable composition layer, a strain (stress) due to heat tends to remain in the polarizer because the difference of the thermal expansion coefficient between the polarizer and the glass film is large. Consequently, the degree of polarization of the polarizer tends to be reduced, the polarizer tends to be deformed at the time of bonding, and when the obtained polarizing plate is stored at a high temperature and a high humidity, the polarizer tends to contract resulting in the deformation or warping of the polarizing plate. The deformation or the warping of the polarizing plate due to the residual strain (stress) is remarkable particularly when the thickness of the polarizer is small.

By contrast, in the present invention, the polarizer and the glass film are bonded to each other through the intermediary of the actinic radiation-curable composition layer. In other words, the polarizer and the glass film are bonded to each other by irradiating the actinic radiation-curable composition layer with an actinic radiation, and hence no heating is needed and the strain (stress) due to heat hardly remains in the polarizer. Accordingly, for example, the deformation of the polarizing plate at the time of bonding, deformation of the polarizing plate when the rolled body of the polarizing plate is stored at a high temperature and a high humidity, and warping of the polarizing plate when the display device is stored at a high temperature and a high humidity can be limited. Additionally, the thin film polarizer is smaller in the contraction force of the polarizer due to heat or humidity than conventional thick film polarizers.

Additionally, by setting the optical transmittance at 380 nm of the actinic radiation-curable composition layer at 5% or more and 40% or less, when the actinic radiation-curable composition layer is irradiated with actinic radiation through the glass film, curing of the actinic radiation-curable composition in the vicinity of the polarizer can be slightly limited without hindering the curing of the actinic radiation-curable composition in the vicinity of the glass film. Accordingly, in the adhesive layer formed of a cured product of the actinic radiation-curable composition, the adhesive strength thereof to the glass film can be increased, and at the same time, the adhesive strength thereof to the polarizer can be reduced. Consequently, during storage at a high temperature and a high humidity, the contraction stress of the polarizer due to heat or humidity can be appropriately absorbed in the adhesive layer, and hence the adhesiveness between the adhesive layer and the polarizer tends to be maintained.

Moreover, by laminating the polarizer and the glass film on each other such that the dyed surface of the polarizer is disposed on the glass film side, scratching of the dyed surface of the polarizer and deformation of the polarizer due to the heat or humidity from the external environment can be limited. Accordingly, while the polarization performance of the polarizing plate is being maintained at a satisfactory level, reduction or unevenness of the degree of polarization of the polarizer when the rolled body of the polarizing plate is stored at a high temperature and a high humidity can be suppressed.

3. Image Display Device

An image display device of the present invention can be a liquid crystal display device or an organic EL display device including the polarizing plate of the present invention.

The liquid crystal display device has a liquid crystal cell, first and second polarizing plates sandwiching the liquid crystal cell, and a backlight. At least the first polarizing plate disposed on the viewing side of the liquid crystal cell can be the polarizing plate of the present invention, and preferably both of the first polarizing plate disposed on the viewing side of the liquid crystal cell and the second polarizing plate disposed on the backlight side can each be the polarizing plate of the present invention.

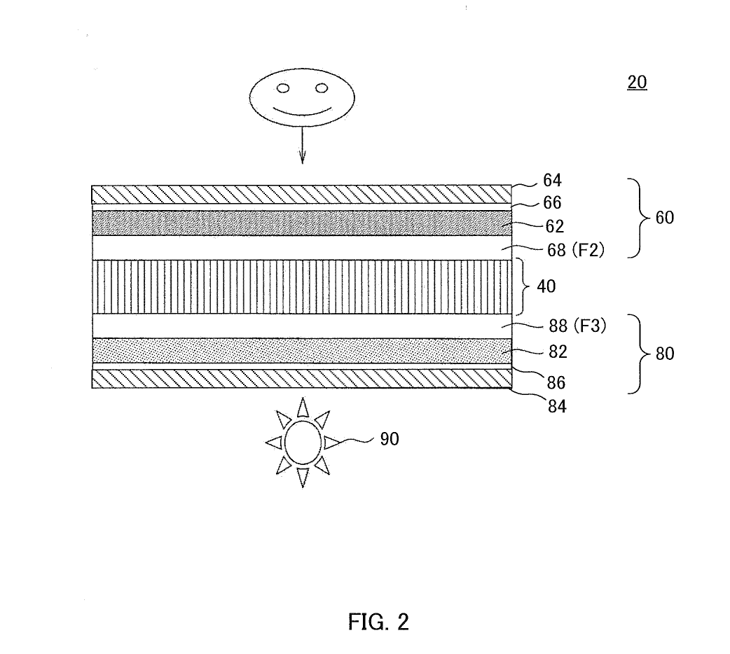

FIG. 2 is a schematic diagram showing an example of a structure of a liquid crystal display device. As shown in FIG. 2, liquid crystal display device 20 has liquid crystal cell 40, first polarizing plate 60 and second polarizing plate 80 sandwiching liquid crystal cell 40, and backlight 90. FIG. 2 shows an example in which both of first polarizing plate 60 and second polarizing plate 80 are the polarizing plates of the present invention.

The display type of liquid crystal cell 40 is not particularly limited, and examples of the display type include: TN (Twisted Nematic) type, STN (Super Twisted Nematic) type, IPS (In-Plane Switching) type, OCB (Optically Compensated Birefringence) type, VA (Vertical Alignment) type (inclusive of MVA; Multi-domain Vertical Alignment or PVA; Patterned Vertical Alignment) and HAN (Hybrid Aligned Nematic) type. In order to widen the viewing angle, an IPS-type liquid crystal cell is preferable.

An IPS-type liquid crystal cell includes two transparent substrates and a liquid crystal layer being disposed between the transparent substrates and including liquid crystal molecules.

Of the two transparent substrates, only one transparent substrate includes pixel electrodes and counter electrodes disposed thereon. The transparent substrate on which pixel electrodes and counter electrodes are disposed is preferably disposed on the side of backlight 80.

The liquid crystal layer includes liquid crystal molecules having negative dielectric anisotropy (Δ∈<0) or positive dielectric anisotropy (Δ∈>0). When the electric voltage is not applied (i.e., no electric field is formed between the pixel electrodes and the counter electrodes), the liquid crystal molecules are oriented in such a way that the long axis of the liquid crystal molecules is horizontal to the surface of the transparent substrates.

In the liquid crystal cell formed as described above, image signals (voltages) are applied to the pixel electrodes, and the electric fields are formed between the pixel electrodes and the counter electrodes in relation to the substrate surfaces. Thus, the liquid crystal molecules oriented horizontally to the substrate surfaces are rotated within the plane horizontal to the substrate surfaces. Thus, the liquid crystal layer is driven, whereby the transmittance and the reflectance of each of the subpixels are changed for displaying an image.

First polarizing plate 60 is the polarizing plate of the present invention, and is disposed on the viewing side surface of liquid crystal cell 40. First polarizing plate 60 has first polarizer 62, glass film 64 disposed on the viewing side surface of first polarizer 62 through the intermediary of adhesive layer 66 formed of a cured product of the actinic radiation-curable composition and protective film 68 (F2) disposed on the surface on the side of liquid crystal cell 40 of first polarizer 62.

Similarly, second polarizing plate 80 is the polarizing plate of the present invention, and is disposed on the surface on the side of backlight 90 of liquid crystal cell 40. Second polarizing plate 80 has second polarizer 82, glass film 84 disposed on the surface on the side of backlight 90 through the intermediary of adhesive layer 86 formed of a cured product of the actinic radiation-curable composition and protective film 88 (F3) disposed on the surface on the side of liquid crystal cell 40 of second polarizer 82.

At least one of protective films 68 (F2) and 88 (F3) may be dispensed with, if necessary.

FIG. 2 shows an example in which both of first polarizing plate 60 and second polarizing plate 80 are the polarizing plates of the present invention; alternatively, the polarizing plate of the present invention may be adopted only for first polarizing plate 60, and an usual polarizing plate may be adopted for the second polarizing plate. In such a case, in the second polarizing plate, the protective film to be disposed on the side of backlight 90 of the polarizer can be a transparent protective film Examples of such a transparent protective film include a cellulose ester film. Examples of the cellulose ester film include commercially available cellulose ester films (such as Konica Minolta TAC KC8UX, KC5UX, KC8UCR3, KC8UCR4, KC8UCR5, KC8UY, KC6UY, KC4UY, KC4UE, KC8UE, KC8UY-HA, KC8UX-RHA, KC8UXW-RHA-C, KC8UXW-RHA-NC and KC4UXW-RHA-NC, all manufactured by Konica Minolta Opt, Inc.).

The thickness of the transparent protective film is not particularly limited, and is about 10 to 200 μm, preferably 10 to 100 μm and more preferably 10 to 70 μm.

As described above, in the liquid crystal display device of the present invention, at least the polarizer on the viewing side of the polarizing plate and the glass film are laminated on each other without intermediary of the protective film. Accordingly, the liquid crystal display device of the present invention can be reduced in thickness as compared with conventional liquid crystal display devices where the polarizer on the viewing side of the polarizing plate and the glass film are laminated on each other through the intermediary of a protective film. Moreover, the thickness of the polarizer is sufficiently smaller than those of conventional polarizers, and hence the thickness of the liquid crystal display device including such a thinner polarizer can be made highly large.

In the polarizer included in the polarizing plate of the present invention, no strain (stress) due to heat remains as described above. Consequently, even after the display device including the polarizing plate of the present invention is stored at a high temperature and a high humidity, warping of the polarizing plate due to the strain (stress) remaining in the polarizer can be limited. Accordingly, the contrast unevenness and the display unevenness of the display device can be limited.

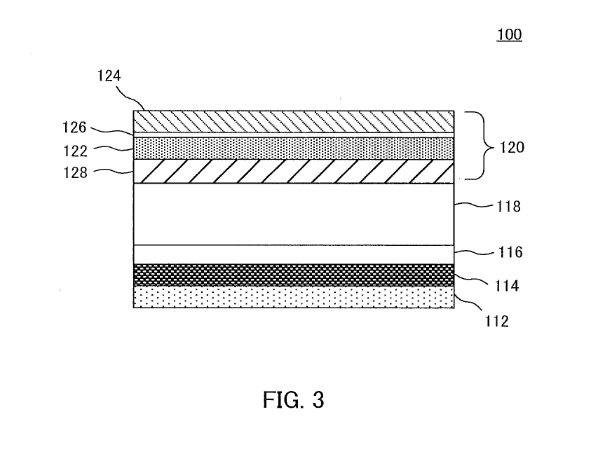

FIG. 3 is a schematic diagram showing an example of the structure of an organic EL display device. As shown in FIG. 3, organic EL display device 100 has light reflection electrode 112, light emitting layer 114, transparent electrode layer 116, transparent substrate 118 and circularly polarizing plate 120, in the order mentioned.

Light reflection electrode 112 is preferably formed of a metal material that exhibits high light reflectance. Examples of the metal material include Mg, MgAg, MgIn, Al and LiAl. Light reflection electrode 112 can be formed by a sputtering method. Light reflection electrode 112 may be subjected to patterning.

Light emitting layer 114 includes an R (red) light emitting layer, a G (green) light emitting layer and a B (blue) light emitting layer. Each of the light emitting layers includes a light emitting material. The light emitting materials may be either inorganic compounds or organic compounds, and are preferably organic compounds.

Each of the light emitting layers further includes a charge transport material, and may further have a function as a charge transport layer, and alternatively further includes a hole transport material and may further have a function as a hole transport layer. When each of the light emitting layers does not include a charge transport material or a hole transport material, organic EL display device 100 can further have a charge transport layer or a hole transport layer.

Each of the light emitting layers is obtained by being subjected to patterning. The patterning can be performed by using, for example, a photomask. Light emitting layer 114 can be formed, for example, by depositing a light emitting material.

Transparent electrode layer 116 generally may be an ITO electrode. Transparent electrode layer 116 can be formed, for example, by a sputtering method. Transparent electrode layer 116 may be subjected to patterning.

Transparent substrate 118 may be any substrate capable of allowing light to pass therethrough, and can be, for example, a glass substrate, a plastic film or a thin film.

Circularly polarizing plate 120 is the polarizing plate of the present invention, and has polarizer (linearly polarizing film) 122, glass film 124 disposed on the viewing side surface of polarizer 122 through the intermediary of adhesive layer 126 formed of a cured product of an actinic radiation-curable composition, and λ/4 plate 128 disposed on the surface on the side of transparent substrate 118 of polarizer 122. The intersection angle between the slow axis of λ/4 plate 128 and the absorption axis of polarizer 122 is preferably in a range of 45±2°.

In organic EL display device 100, when the energization between light reflection electrode 112 and transparent electrode layer 116 is made, light emitting layer 114 emits light for image displaying. By forming the R (red) light emitting layer, the G (green) light emitting layer and the B (blue) light emitting layer so as to be able to be energized individually, displaying of full color images can be performed.

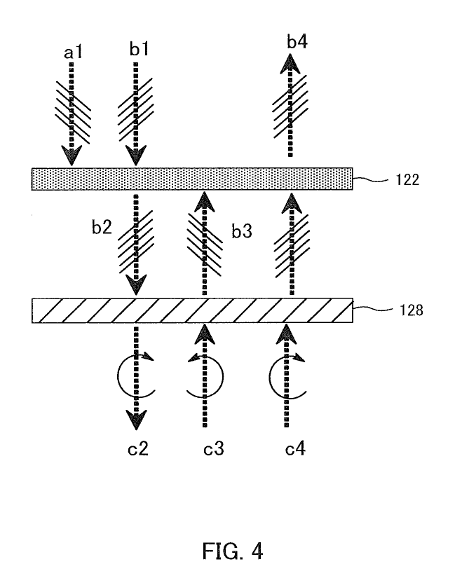

FIG. 4 is a schematic diagram illustrating the reflection preventing function based on circularly polarizing plate 120. In FIG. 4, adhesive layer 126 formed of a cured product of the actinic radiation-curable composition and glass film 124 are not illustrated.

As shown in FIG. 4, a light beam (inclusive of a1 and b1) is incident from the outside in parallel to the normal of the display screen of organic EL display device 100, only the linearly polarized light (b1) parallel to the transmission axis direction of polarizer (LP) 122 passes through polarizer (LP) 122. The other linearly polarized light (a1) not parallel to the transmission axis direction of polarizer (LP) 122 is absorbed by polarizer (LP) 122. The linearly polarized light component (b2) passing through polarizer (LP) 122 passes through 214 plate 128 to be transformed into circularly polarized light (c2). The circularly polarized light (c2) is reflected on light reflection electrode 112 (see FIG. 2) of organic EL display device 100 to be reversely rotating circularly polarized light (c3). The reversely rotating circularly polarized light (c3) is transformed into linearly polarized light (b3) in the direction perpendicular to the transmission axis direction of polarizer (LP) 122 by passing through λ/4 plate 128. The linearly polarized light (b3) cannot pass through polarizer (LP) 122 and is absorbed by polarizer (LP) 122.

In this way, the light beam (inclusive of a1 and b1) incident from the outside on organic EL display device 100 is wholly absorbed by polarizer (LP) 122, and hence if the light is reflected on the light reflection electrode of organic EL display device 100, the reflected light is not emitted to the outside. Consequently, the degradation of the image display properties due to the background reflection can be prevented.

The light from the inside of organic EL display device 100, namely, the light from light emitting layer 114 (see FIG. 2) includes two types of circularly polarized light components (c3 and c4). One circularly polarized light (c3) is transformed into the linearly polarized light (b3) in the direction perpendicular to the transmission axis direction of polarizer (LP) 122, by passing through 214 plate 128. Then, the linearly polarized light (b3) cannot pass through polarizer (LP) 122 and is absorbed by polarizer (LP) 122. The other circularly polarized light (c4) is transformed into the linearly polarized light (b4) parallel to the transmission axis direction of polarizer (LP) 122, by passing through 214 plate 128. Then, the linearly polarized light (b4) passes through polarizer (LP) 122 to be the linearly polarized light (b4) and the linearly polarized light (b4) is recognized as an image.

Between polarizer (LP) 122 and λ/4 plate 128, a reflective polarizing plate (not shown) may be further disposed which reflects the linearly polarized light (b3) in the direction perpendicular to the transmission axis direction of polarizer (LP) 122. The reflective polarizing plate does not allow the linearly polarized light (b3) to be absorbed by polarizer (LP) 122 but allows the linearly polarized light (b3) to be reflected on polarizer (LP) 122, and the reflected light is again reflected on light reflection electrode 112 (see FIG. 2), and thus can be transformed into the linearly polarized light (b4) parallel to the transmission axis direction of polarizer (LP) 122. In other words, by further disposing the reflective polarizing plate, the whole light (c3 and c4) emitted from the light emitting layer can be emitted to the outside.

Thus, the organic EL display device of the present invention is also reduced in thickness as compared to conventional display devices.

As described above, in the polarizer included in the polarizing plate of the present invention, a strain (stress) due to heat does not remain. Accordingly, even after the storage of the organic EL display device including the polarizing plate of the present invention at a high temperature and a high humidity, warping of the polarizing plate due to the strain (stress) remaining in the polarizer can be limited. Thus, the front-surface luminance unevenness and the reflectance unevenness of the organic EL display device can be limited.

### EXAMPLES

Hereinafter, the present invention will be described in more detail with reference to Examples. The scope of the present invention shall not be construed as being limited by Examples.

### 1. Manufacture of Polarizer

### Manufacture Example 1

### Application Step

A base material film was prepared by corona treating of a surface of a 120-μm thick amorphous polyethylene terephthalate film subjected to antistatic treatment. A polyvinyl alcohol powder (trade name: JC-25, average degree of polymerization: 2,500, degree of saponification: 99.0 mol % or more, manufactured by Japan Vam & Poval Co., Ltd.) was dissolved in hot water set at 95° C. to prepare a polyvinyl alcohol aqueous solution having a concentration of 8 mass %. The obtained polyvinyl alcohol aqueous solution was applied to the base material film with a lip coater and dried at 80° C. for 20 minutes. Thus, a laminate composed of the base material film and a polyvinyl alcohol resin layer. The thickness of the polyvinyl alcohol resin layer in the laminate was 12.0 μm.

Stretching Step

The obtained laminate was subjected to a free-end uniaxially stretching in the conveying direction (MD direction) at 160° C. with a stretching magnification factor of 5.3. The thickness of the polyvinyl alcohol resin layer in the laminate after stretching was 5.6 μm.

Dyeing Step

The laminate after stretching was immersed in a warm water bath at 60° C. for 60 seconds, and then immersed in an aqueous solution containing 0.05 parts by mass of iodine and 5 parts by mass of potassium iodide per 100 parts by mass of water, at a temperature of 28° C. for 60 seconds. Next, while a certain tension was being applied to the laminate after stretching, the laminate was immersed in a boric acid aqueous solution containing 7.5 parts by mass of boric acid and 6 parts by mass of potassium iodide per 100 parts by mass of water at a temperature of 73° C. for 300 seconds. Then, the obtained laminate was washed with pure water at 15° C. for 10 seconds. While a certain tension was being applied to the obtained laminate, the laminate was dried at 70° C. for 300 seconds to yield a laminate composed of the base material film and polarizer 1. The thickness of polarizer 1 was 5.6 μm.

The thickness of the layer dyed with iodine in polarizer 1 of the obtained laminate was measured by the following method. Specifically, an electron micrograph of a cross section of polarizer 1 was taken at a magnification of 15,000 with a scanning electron microscope (SEM). Consequently, on the surface layer of polarizer 1, not in contact with the base material film, a 2.2-μm thick layer dyed with iodine was identified.

### Manufacture Example 2

A 75-μm thick polyvinyl alcohol film (vinylon film VF-P#7500, manufactured by Kuraray Co., Ltd.) was subjected to dry uniaxial stretching in the conveying direction (MD direction) at 125° C. with a stretching magnification factor of 5.2.

While a certain tension was being applied to the polyvinyl alcohol film after stretching, the film was immersed in an aqueous solution containing 0.05 parts by mass of iodine and 5 parts by mass of potassium iodide per 100 parts by mass of water, at a temperature of 28° C. for 60 seconds. Next, while a certain tension was being applied to the obtained film, the film was immersed in a boric acid aqueous solution containing 7.5 parts by mass of boric acid and 6 parts by mass of potassium iodide per 100 parts by mass of water at a temperature of 73° C. for 300 seconds. Then, the obtained film was washed with pure water at 15° C. for 10 seconds. While a certain tension was being applied to the obtained film, the film was dried at 70° C. for 300 seconds. Next, the ends and the edges of the obtained film were cut off to yield polarizer 2 (polarizing film) having a width of 1,300 mm. The thickness of polarizer 2 (polarizing film) was 33 μm.

The thickness of the layer dyed with iodine of polarizer 2 was measured in the same manner as in Manufacture Example 1, and consequently, a 2.0-μm thick layer dyed with iodine was identified on each of both surfaces of polarizer 2.

### Manufacture Example 3

Polarizer 3 was obtained in the same manner as in Manufacture Example 2 except that a 30-μm thick polyvinyl alcohol film was used and that the stretching magnification factor was set at 5.7. The thickness of polarizer 3 (polarizing film) was 9.2 μm.

The thickness of the layer dyed with iodine of polarizer 3 was measured in the same manner as in Manufacture Example 1, and consequently, a 2.0-μm thick layer dyed with iodine was identified on each of both surfaces of polarizer 3.

### 2. Other Materials

1) Glass Film

Alkali-free glass films having the following thickness values were prepared by float method.

Glass film 1: thickness: 150 μm

Glass film 2: thickness: 300 μm

Glass film 3: thickness: 88 μm

Glass film 4: thickness: 45 μm

2) Curable Compounds

Cyracure UVR6105 (alicyclic epoxy compound, manufactured by Union Carbide Corp.)

Mixture of methyl methacrylate/glycidyl methacrylate

### 3. Manufacture of Polarizing Plate

### Example 1

According to the following steps 1 to 6, polarizer 3 obtained in Manufacture Example 3 and glass film 1 were laminated on each other.

Step 1: To one surface of polarizer 3 obtained in Manufacture Example 3, curable composition 1 having the following composition was applied such that the thickness of the composition layer after curing was 15 μm.

### (Curable Composition 1)

Cyracure UVR6105 (alicyclic epoxy compound, manufactured by Union Carbide Corp.): 87 parts by mass

UVI-6990 (photocationic initiator, manufactured by Union Carbide Corp.): 5.5 parts by mass

L-7604 (surfactant, manufactured by Nippon Unicar Co., Ltd.): 0.5 parts by mass

NAC silicone A-187 (γ-glycidoxypropyltrimethoxysilane, manufactured by Nippon Unicar Co., Ltd.): 2 parts by mass

Tinuvin 928 (ultraviolet absorber, manufactured by Ciba Japan K.K.): 7.0 parts by mass

Step 2: Glass film 1 was disposed on the layer of curable composition 1 obtained in Step 1.

Step 3: The laminate having the configuration polarizer 3/layer of curable composition 1/glass film 1 obtained in Step 2 was irradiated with ultraviolet ray from the side of glass film 1 with a high-pressure mercury lamp, and thus curable composition 1 was cured for lamination. The irradiation was performed with 120 W×10 m×3 passes (irradiation dose: 900 mJ), and the conveying speed was set at about 2 m/min.

Step 4: The laminate obtained in Step 3 was dried in a dryer set at 80° C. for 2 minutes to yield polarizing plate 101.

### Example 2

Step 1: To the surface (the surface dyed with iodine) of polarizer 1 obtained in Manufacture Example 1, curable composition 2 having the following composition was applied such that the thickness of the composition layer after curing was 15 μm.

### (Curable Composition 2)

Cyracure UVR6105 (alicyclic epoxy compound, manufactured by Union Carbide Corp.): 87 parts by mass

UVI-6990 (photocationic initiator, manufactured by Union Carbide Corp.): 5.5 parts by mass

L-7604 (surfactant, manufactured by Nippon Unicar Co., Ltd.): 0.5 parts by mass NAC silicone A-187 (γ-glycidoxypropyltrimethoxysilane, manufactured by Nippon Unicar Co., Ltd.): 2 parts by mass

Step 2: Glass film 1 was disposed on the layer of curable composition 2 obtained in Step 1.

Step 3: The laminate having the configuration polarizer 1/layer of curable composition 2/glass film 1 obtained in Step 2 was irradiated with ultraviolet ray from the side of glass film 1 with a high-pressure mercury lamp, and thus layer of curable composition 2 was cured for lamination. The irradiation was performed with 120 W×10 m×3 passes (irradiation dose: 900 mJ), and the conveying speed was set at about 2 m/min.

Step 4: The laminate obtained in Step 3 was dried in a dryer set at 80° C. for 2 minutes.

Step 5: The base material film was removed from the obtained laminate having the configuration base material film/polarizer 1/adhesive layer formed of cured product of curable composition 2/glass film 1 to yield polarizing plate 102. The base material film was easily removed.

### Examples 3 to 6

Polarizing plates 103 to 106 were obtained in the same manner as in Example 2 except that the thickness of the glass film was changed as shown in Table 1.

### Example 7

Polarizing plate 107 was obtained in the same manner as in Example 5 except that curable composition 1 was replaced with curable composition 3 having the following composition.

### (Curable Composition 3)

Cyracure UVR6105 (alicyclic epoxy compound, manufactured by Union Carbide Corp.): 82 parts by mass

UVI-6990 (photocationic initiator, manufactured by Union Carbide Corp.): 5.5 parts by mass

L-7604 (surfactant, manufactured by Nippon Unicar Co., Ltd.): 0.5 parts by mass

NAC silicone A-187 (γ-glycidoxypropyltrimethoxysilane, manufactured by Nippon Unicar Co., Ltd.): 2 parts by mass

Tinuvin 928 (ultraviolet absorber, manufactured by Ciba Japan K.K.): 7.0 parts by mass

Tinuvin 171 (ultraviolet absorber, manufactured by Ciba Japan K.K.): 5.0 parts by mass

### Examples 8 and 9

According to the following Steps 1 to 6, polarizing plates 108 and 109 were obtained in each of which the adhesive layer formed of the cured product of curable composition 1 was laminated on the surface not dyed with iodine of polarizer 1.

Step 1: A masking film (surface protective material E-MASK HR6030, manufactured by Nitto Denko Corp.) was laminated on the surface (surface dyed with iodine) of polarizer 1 of the laminate obtained in Manufacture Example 1, and then the base material film was removed.

Step 2: To the surface (surface not dyed with iodine) of polarizer 1 of the laminate obtained in Step 1, which laminate is composed of the masking film and polarizer 1, curable composition 1 was applied such that the thickness of the composition layer after curing was 15 μm.

Step 3: Glass film 1 or 3 was disposed on the obtained layer of curable composition 1.

Step 4: The laminate having the configuration masking film/polarizer 1/layer of curable composition 1/glass film 1 or 3 obtained in Step 3 was irradiated with ultraviolet ray from the side of the glass film with a high-pressure mercury lamp, and thus curable composition 1 was cured for lamination. The irradiation was performed with 120 W×10 m×3 passes (irradiation dose: 900 mJ), and the conveying speed was set at about 2 m/min.

Step 5: The laminate obtained in Step 4 was dried in a dryer set at 80° C. for 2 minutes.

Step 6: The masking film was removed from the obtained laminate having the configuration masking film/polarizer 1/adhesive layer formed of cured product of curable composition 1/glass film 1 or 3 to yield polarizing plate 108 or 109.

### Example 10

Polarizing plate 110 was obtained in the same manner as in Example 4 except that curable composition 1 was replaced with curable composition 4 having the following composition.

### (Curable Composition 4)

Methyl methacrylate: 100 parts by weight

Glycidyl methacrylate: 10 parts by weight

Irgacure 184 (manufactured by Ciba Japan K.K.): 5.0 parts by mass

### Example 11

Polarizing plate 111 was obtained in the same manner as in Example 4 except that curable composition 1 was replaced with curable composition 5 having the following composition.

### (Curable Composition 5)

Methyl methacrylate: 100 parts by weight

Glycidyl methacrylate: 10 parts by weight

Irgacure 184 (manufactured by Ciba Japan K.K.): 5.0 parts by mass

Ultraviolet absorber: Tinuvin 928 (manufactured by Ciba Japan K.K.): 7.0 parts by mass

### Comparative Example 1

According to the following steps 1 to 6, polarizer 1 obtained in Manufacture Example 1 and glass film 1 were laminated on each other.

Step 1: To the dyed surface of polarizer 1 obtained in Manufacture Example 1, curable composition 6 (thermally curable composition) having the following composition was applied such that the thickness of the composition layer after curing was 15 μm.

### (Curable Composition 6)

Methyl methacrylate: 100 parts by weight

Glycidyl methacrylate: 10 parts by weight

Azobisisobutyronitrile: 1 part by weight

Step 2: Glass film 1 was disposed on the layer of curable composition 6 obtained in Step 1.

Step 3: The laminate having the configuration base material film/polarizer 1/layer of curable composition 6/glass film 1 obtained in Step 2 was subjected to interlayer lamination at a temperature of 120° C. at a pressure of 20 to 30 N/cm² for 60 minutes.

Step 4: The laminate obtained in Step 3 was dried in a dryer set at 80° C. for 2 minutes. Thus, the layer of curable composition 6 was thermally cured.

Step 5: The base material film was removed from the obtained laminate having the configuration base material film/polarizer 1/adhesive layer formed of cured product of curable composition 6/glass film 1 to yield polarizing plate 112.

### Comparative Example 2

Polarizing plate 113 was obtained in the same manner as in Example 1 except that polarizer 3 was replaced with polarizer 2.

The curling and the durability of each of the obtained polarizing plates were measured by the following methods.

(Evaluation of Curling)

Each of the obtained polarizing plates was cut out to a size of a width of 50 mm×a lengthwise length of 30 mm. Each of the obtained polarizing plates was allowed to stand on a horizontal substrate for 24 hours in an environment at 23° C. and a relative humidity of 80%, and then the curling shape of each of the polarizing plates was visually observed. The curling of each of the polarizing plates was evaluated according to the following standards.

A: The polarizing plate is in a nearly flat state and no occurrence of curling is found.

B: The four corners of the polarizing plate are slightly raised, and the occurrence of weak curling is found, but the curling is at a level of practically causing no problem.

C: Obvious occurrence of curling is found at a level that makes handling difficult.

D: Curling state is severe, and is at a level that makes handling extremely difficult.

(Durability 1: Variation of Degree of Polarization after Storage at High Temperature and High Humidity)

Each of the obtained polarizing plates was cut out to a 42-inch liquid crystal panel size (930 mm×520 mm), and was allowed to stand for 24 hours in an environment at 23° C. and a relative humidity of 55%. Subsequently, for each of the obtained polarizing plates, the degree of polarization C(0) at the center (ρ0) of the diagonal and the degree of polarization C(75) at the point (ρ75) on the diagonal, separated by 75% from the center of the diagonal (namely, 75% of the total length between the center and one end of the diagonal) were measured. The measurements of the degree of polarization were made using an automatic polarizing film analyzer VAP-7070 (manufactured by JASCO Corp.) and a devoted program.

Next, the polarizing plates were allowed to stand for 300 hours in a high temperature-high humidity environment at a temperature of 60° C. and a relative humidity of 90%. Subsequently, for each of the polarizing plates, the degree of polarization C′(0) at the center (ρ0) of the diagonal and the degree of polarization C′(75) at the point (ρ75) on the diagonal, separated by 75% from the center of the diagonal were measured in the same manner as described above.

Then, the difference between the variation of the degree of polarization (=C′(0)−C(0)) at the center (ρ0) of the diagonal and the variation of the degree of polarization (=C′(75)−C(75)) at the point (ρ75) separated by 75% from the center was taken as the variation difference (Δdegree of polarization) of the degree of polarization.

Variation difference of degree of polarization (Δdegree of polarization)=variation (%) of degree of polarization at a point separated by 75% (ρ75) from the center−variation (%) of degree of polarization at the center (ρ0) of diagonal [1]

Durability 1 of each of the polarizing plates was evaluated according to the following standards.

A: The Δdegree of polarization is less than 1.0%.

B: The Δdegree of polarization is 1.0% or more and less than 2.0%.

C: The Δdegree of polarization is 2.0% or more and less than 5.0%.

D: The Δdegree of polarization is 5.0% or more.

The optical transmittance of each of the adhesive layers formed of cured products of the curable compositions used for the manufacture of the polarizing plates was measured by the following method.

(Optical Transmittance)

The curable compositions used for the manufacture of the polarizing plates were applied to glass substrates and dried under the same conditions as in the manufacture of the polarizing plates, then cured and removed from the glass substrates to yield 15-μm thick cured films. The optical transmittance of each of the cured films thus obtained at a wavelength of 380 nm was measured with a spectrophotometer (the ultraviolet-visible-near infrared spectrophotometer V-670, manufactured by JASCO Corp.).

The evaluation results of Examples 1 to 11 and Comparative Examples 1 and 2 are shown in Table 1.

TABLE 1

| | | | | Polarizer | | | | | | | | |
|---|---|---|---|---|---|---|---|---|---|---|---|---|
| | | | | | | Surface | | | | Evaluations | | |
| | Polarizing | Glass Film | | | | Adhering | Curable Composition | | | Total | | |
| | Plate | | Thickness | | Thickness | to Composition | Type | Transmittance | Thickness | Thickness | | Durability |
| | No. | No | (μm) | No | (μm) | Layer | (No.) | (%) at 380 nm | (μm) | (μm) | Curling | 1 |
| Example 1 | 101 | 1 | 150 | 3 | 9.2 | — | 1 | 35 | 15 | 174 | B | C |
| Example 2 | 102 | 1 | 150 | 1 | 5.6 | Dyed Surface | 2 | 81 | 15 | 171 | B | B |
| Example 3 | 103 | 2 | 300 | 1 | 5.6 | Dyed Surface | 1 | 35 | 15 | 321 | A | B |
| Example 4 | 104 | 1 | 150 | 1 | 5.6 | Dyed Surface | 1 | 35 | 15 | 171 | A | A |
| Example 5 | 105 | 3 | 88 | 1 | 5.6 | Dyed Surface | 1 | 35 | 15 | 109 | A | B |
| Example 6 | 106 | 4 | 45 | 1 | 5.6 | Dyed Surface | 1 | 35 | 15 | 66 | B | B |
| Example 7 | 107 | 3 | 88 | 1 | 5.6 | Dyed Surface | 3 | 18 | 15 | 109 | A | A |
| Example 8 | 108 | 1 | 150 | 1 | 5.6 | Non-Dyed | 1 | 35 | 15 | 171 | A | B |
| | | | | | | Surface | | | | | | |
| Example 9 | 109 | 3 | 88 | 1 | 5.6 | Non-Dyed | 1 | 35 | 15 | 109 | A | C |
| | | | | | | Surface | | | | | | |
| Example 10 | 110 | 1 | 150 | 1 | 5.6 | Dyed Surface | 4 | 78 | 15 | 171 | B | B |
| Example 11 | 111 | 1 | 150 | 1 | 5.6 | Dyed Surface | 5 | 35 | 15 | 171 | A | A |
| Comparative | 112 | 1 | 150 | 1 | 5.6 | Dyed Surface | 6 | 78 | 15 | 171 | D | D |
| Example 1 | | | | | | | | | | | | |
| Comparative | 113 | 1 | 150 | 2 | 33 | — | 1 | 35 | 15 | 198 | D | D |
| Example 2 | | | | | | | | | | | | |

As can be seen from Table 1, as compared to the polarizing plates of Comparative Examples 1 and 2, the polarizing plates of Examples 1 to 11 were allowed to be thinner, were lower in the occurrence of curling when stored in an environment at a high temperature and a high humidity, and were smaller in the variation of the degree of polarization.

### 4. Manufacture of Rolled Body of Polarizing Plate

### Example 12

According to the description of Japanese Patent Application Laid-Open No. 2010-132349, by the over-flow down-draw method, long glass film 5 having a thickness of 100 μm and a flexural strength of 92.5 MPa was obtained. Next, the obtained long glass film was wound around a winding core of 120 mm in diameter in the direction perpendicular to the width direction to yield a rolled body.

A long polarizing plate was manufactured in the same manner as in Example 5 except that in place of glass film 3, glass film 5 unwound from the obtained rolled body was used. The long polarizing plate was 1,300 mm in the length W in the width direction and 1,000 m in the length L in the lengthwise direction, and the ratio L/W of the length L in the lengthwise direction to the length W in the width direction was 769. The obtained long polarizing plate was wound around a winding core of 120 mm in diameter to yield a rolled body of polarizing plate 201.

### Comparative Example 3

A long polarizing plate was manufactured in the same manner as in Comparative Example 1 except that in place of glass film 1, glass film 5 unwound from the rolled body obtained in Example 10 was used, and the obtained long polarizing plate was wound around a winding core of 120 mm in diameter to yield a rolled body of polarizing plate 202.

The durability 1 and the durability 2 of the obtained rolled body of the polarizing plate were measured by the following methods.

(Durability 1: Variation of Degree of Polarization after Storage at High Temperature and High Humidity)

The polarizing plate was unwound from the obtained rolled body of the polarizing plate, the central portion in the width direction at a position of 500 m (in the lengthwise direction) from the outer portion of the roll was cut out to a 42-inch liquid crystal panel size (930 mm×520 mm) The durability 1 of the obtained polarizing plate was measured in the same manner as described above.

(Durability 2: Unevenness of Degree of Polarization after Storage of Rolled Body at High Temperature and High Humidity)

The obtained rolled body of the polarizing plate was allowed to stand for 1 week in a high temperature-high humidity environment at a room temperature of 60° C. and a relative humidity of 90%. Subsequently, for the polarizing plate in the outermost circumferential portion of the obtained rolled body, the degree of polarization at each of the points separated by 25%, 50% and 75% of the total width, respectively, in the width direction from one end was measured. Next, the same measurements were repeated in the lengthwise direction of the polarizing plate, at every 10 m interval, in a range of 500 m from the outer portion side to the winding core side of the rolled body, and the degrees of polarization at 150 points (three points x 50) in total were measured. With the average value of the whole measurement points defined to be 100, the proportion (%) of the difference between the maximum value and the minimum value of the degrees of polarization at the whole measurement points was determined as “the variation of the degree of polarization 1.” The measurement of the degree of polarization was performed by using an automatic polarizing film analyzer VAP-7070 (manufactured by JASCO Corp.) and a devoted program.

In the same manner as described above, for a rolled body of a polarizing plate immediately after manufacture, and not stored at a high temperature and a high humidity, degrees of polarization at 150 points in total were measured. Then, with the average value of the whole measurement points defined to be 100, the proportion (%) of the difference between the maximum value and the minimum value of the degrees of polarization at the whole measurement points was determined as “the variation of the degree of polarization 2.”

Then, the obtained variation of the degree of polarization 1 and the obtained degree of the polarization 2 were substituted into the following formula to determine the increment width of the variation of the degree of polarization.

Increment width (%) of variation=variation (%) of degree of polarization 1−variation (%) of degree of polarization 2 [2]

Then, the unevenness of the degree of polarization after the storage of the rolled body at a high temperature and a high humidity was evaluated according to the following standards.

A: The increment width of the variation is less than 1.0%.

B: The increment width of the variation is 1.0% or more and less than 2.0%.

C: The increment width of the variation is 2.0% or more and less than 5.0%.

D: The increment width of the variation is 5.0% or more.

The results of Example 12 and Comparative Example 3 are shown in Table 2.

TABLE 2

| | | Glass Film | | Polarizer | | | Curable Composition | | | Evaluations | | |
|---|---|---|---|---|---|---|---|---|---|---|---|---|
| | Polarizing | | Thick- | | | Surface Adhering | | Transmittance | | Total | | |
| | Plate | | ness | | Thickness | to Composition | Type | (%) | Thickness | Thickness | Durability | Durability |
| | No. | No | (μm) | No | (μm) | Layer | (No.) | at 380 nm | (μm) | (μm) | 1 | 2 |
| Example 12 | 201 | 5 | 100 | 1 | 5.6 | Dyed Surface | 1 | 35 | 15 | 115 | B | C |
| Comparative | 202 | 5 | 100 | 1 | 5.6 | Dyed Surface | 6 | 78 | 15 | 115 | D | D |
| Example 3 | | | | | | | | | | | | |

As can be seen from Table 2, as compared to the polarizing plate of Comparative Example 3, the polarizing plate of Example 12 was smaller (better in the durability 1), even in a rolled state, in the variation of the degree of polarization after the storage at a high temperature and a high humidity, and the unevenness of the degree of polarization after the storage of the rolled body at a high temperature and a high humidity was also smaller (also better in the durability 2).

### 3. Manufacture of Liquid Crystal Display Devices

### Example 13

A liquid crystal display device “Regza 47ZG2, manufactured by Toshiba Corp.” including a transverse electric field switching mode (IPS mode) liquid crystal cell was prepared. From the liquid crystal display device, the liquid crystal panel was taken out, two polarizing plates disposed on both surfaces of the liquid crystal cell were removed, and the glass surfaces (front and back surfaces) of the liquid crystal cell were washed.

Polarizing plate 101 was attached as the first polarizing plate (the polarizing plate on the viewing side) to the surface on the viewing side of the liquid crystal cell through the intermediary of a 20-μm thick acrylic adhesive layer. The attachment of polarizing plate 101 was performed in such a way that the polarizer was brought into contact with the liquid crystal cell, and the absorption axis of the polarizer was parallel (0±0.2 degree) to the long sides of the liquid crystal cell.

Polarizing plate 101 was attached as the second polarizing plate (the polarizing plate on the backlight side) to the surface on the backlight side of the liquid crystal cell through the intermediary of a 20-μm thick acrylic adhesive layer. The attachment of the second polarizing plate was performed in such a way that the polarizer was brought into contact with the liquid crystal cell, and that the absorption axis of the polarizer was parallel (0±0.2 degree) to the short sides of the liquid crystal cell. Thus, liquid crystal display device 301 was obtained.

### Examples 14 to 21 and Comparative Examples 4 and 5

Liquid crystal display devices 302 to 311 were obtained in the same manner as in Example 13 except that the first polarizing plates (the polarizing plates on the viewing side) and the second polarizing plates (the polarizing plates on the backlight side) were changed as shown in Table 3.

### Examples 22 and 23

The liquid crystal panel was taken out from the Regza 47ZG2 manufactured by Toshiba Corp., and only the polarizing plate disposed on the surface on the viewing side of the liquid crystal cell was removed. Then, liquid crystal display devices 312 and 313 were obtained in the same manner as in Example 13 except that after the surface on the viewing side of the liquid crystal cell was washed, the polarizing plates shown in Table 3 were attached through the intermediary of a 20-μm thick acrylic adhesive layer.

The contrast ratio and the corner unevenness of each of obtained liquid crystal display devices 301 to 313 were evaluated by the following methods.

(Contrast Ratio)

When a white image was displayed on each of these liquid crystal display devices, the Y value in the XYZ display system in the direction of the azimuthal angle of 45° and in the direction of the polar angle of 60° of the display screen was measured with the “EZ Contrast 160D” (product name) manufactured by ELDIM Co. Similarly, when a black image was displayed on each of these liquid crystal display devices, the Y value in the XYZ display system in the direction of the azimuthal angle of 45° and in the direction of the polar angle of 60° of the display screen was measured. Then, from the Y value (YW) in the white image and the Y value (YB) in the black image, the contrast ratio “YW/YB” in the oblique direction was calculated. The measurement of the contrast ratio was performed in a dark room at a temperature of 23° C. and a relative humidity of 55%. The azimuthal angle of 45° represents a direction rotated by 45° counterclockwise wherein the long side of the display screen is defined to have an azimuthal angle of 0° in the plane of the display screen. The polar angle of 60° represents a direction inclined by 60° from the normal wherein the normal direction of the display screen is defined to have a polar angle of 0°. The higher the contrast ratio, preferably the higher the contrast.

(Corner Unevenness)

The liquid crystal display devices used in the above-described measurement of the contrast ratio were stored for 1,500 hours in an environment at 60° C. and a relative humidity of 90%. Subsequently, the obtained liquid crystal display devices were moisture-conditioned for 20 hours in an environment at 25° C. and a relative humidity of 60%, and light leakage was observed when the backlights were turned on and black display was performed. The evaluation of the light leakage was performed according to the following standards.

A: Light leakage at the margin (corner areas) of the display screen is not found at all.

B: Light leakage at the margin (corner areas) of the display screen causes almost no concern.

C: Light leakage at the margin (corner areas) of the display screen is found.

D: Light leakage at the margin (corner areas) of the display screen is remarkable.

The results obtained in Examples 13 to 23 and Comparative Examples 4 and 5 are shown in Table 3.

TABLE 3

| | | First Polarizing Plate (Viewing Side) | | | | | | | | | |
|---|---|---|---|---|---|---|---|---|---|---|---|
| | Display | | Glass | | | Second Polarizing Plate (Backlight Side) | | | | Evaluations | |
| | Device | | Film | Adhesive Layer | Polarizer | | Polarizer | Adhesive Layer | Glass Film | Contrast | Corner |
| | No. | No. | No. | (Composition No.) | No. | No. | No. | (Composition No.) | No. | Ratio | Unevenness |
| Example 13 | 301 | 101 | 1 | 1 | 3 | 101 | 3 | 1 | 1 | 51 | C |
| Example 14 | 302 | 102 | 1 | 2 | 1 | 102 | 1 | 2 | 1 | 53 | B |
| Example 15 | 303 | 103 | 2 | 1 | 1 | 103 | 1 | 1 | 2 | 57 | B |
| Example 16 | 304 | 104 | 1 | 1 | 1 | 104 | 1 | 1 | 1 | 64 | A |
| Example 17 | 305 | 105 | 3 | 1 | 1 | 105 | 1 | 1 | 3 | 61 | B |
| Example 18 | 306 | 106 | 4 | 1 | 1 | 106 | 1 | 1 | 4 | 59 | B |
| Example 19 | 307 | 107 | 3 | 3 | 1 | 107 | 1 | 3 | 3 | 68 | A |
| Example 20 | 308 | 108 | 1 | 1 | 1 | 108 | 1 | 1 | 1 | 60 | B |
| Example 21 | 309 | 109 | 3 | 1 | 1 | 109 | 1 | 1 | 3 | 56 | A |
| Example 22 | 312 | 104 | 1 | 1 | 1 | (Original Polarizing Plate) | | | | 58 | A |
| Example 23 | 313 | 107 | 3 | 3 | 1 | (Original Polarizing Plate) | | | | 60 | A |
| Comparative | 310 | 112 | 1 | 6 | 1 | 112 | 1 | 6 | 1 | 25 | D |
| Example 4 | | | | | | | | | | | |
| Comparative | 311 | 113 | 1 | 1 | 2 | 113 | 2 | 1 | 1 | 31 | D |
| Example 5 | | | | | | | | | | | |

As can be seen from Table 3, as compared to the display devices of Comparative Examples 4 and 5, the display devices of Examples 13 to 23 were higher in the contrast of the displayed image and lower in the corner unevenness after the storage in an environment at a high temperature and a high humidity.

### 4. Manufacture of Organic EL Display Devices

### Example 24

### Manufacture of Circularly Polarizing Plate

On the surface of polarizer 3 of polarizing plate 101 manufactured in Example 1, an aromatic polycarbonate 214 plate (Pure-Ace WR, R(450)=115 nm, R(550)=138 nm, R(590)=142 nm, R(450)/R(590)=0.81, manufactured by Teijin Chemicals Ltd.) was laminated through the intermediary of a 20-μm thick acrylic adhesive layer to yield circularly polarizing plate 101a. The lamination of polarizer 3 and the 214 plate was performed in such a way that the intersection angle between the absorption axis of polarizer 3 and the slow axis of the 214 plate was 45°±2°.

Manufacture of Organic EL Display Device

As an organic EL display device, the Galaxy S manufactured by Samsung Electronics Co., Ltd. was prepared. The organic EL display device was disassembled, the polarizing plate disposed on the touch panel was removed, and the glass surface of the touch panel was washed.

Then, obtained circularly polarizing plate 101a was laminated on the touch panel such that the λ/4 plate is on the side of the organic EL emitting element, through the intermediary of a 20-μm thick acrylic adhesive layer, to yield organic EL display device 401.

### Examples 25 to 32 and Comparative Examples 6 and 7

Organic EL display devices 402 to 411 were obtained in the same manner as in Example 24 except that polarizing plate 101a was changed as shown in Table 4.

Next, the front-surface luminance unevenness and the reflectance unevenness of each of the obtained organic EL display devices were measured by the following methods.

(Front-Surface Luminance Unevenness)

The obtained organic EL display devices were stored for 1,500 hours in a high temperature-high humidity environment at 60° C. and a relative humidity of 90%, and then moisture-conditioned for 20 hours in an environment at 25° C. and a relative humidity of 60%.

Next, the front-surface luminance was measured for each of the following 13 points in total, namely, the center of the diagonal of the display screen and the points on the diagonal separated from the center by 25%, 50% and 75% of the total length between the center and the one end of the diagonal. The difference between the maximum luminance and the minimum luminance of the measured luminance values was determined, and the proportion of the difference in relation to the average luminance 100 for the 13 points was determined as the Δluminance (%). Then, for each of the organic EL display devices, the front-surface luminance unevenness was evaluated according to the following standards.

The measurement of the luminance was performed by using a spectral radiation luminance meter CS-1000 (manufactured by Konica Minolta Sensing, Inc.), wherein the emission luminance (specifically, the luminance in the direction inclined from the normal by 2°) in the normal direction (front direction) of the display screen was measured.

A: The Δluminance is less than 1.0%.

B: The Δluminance is 1.0% or more and less than 2.0%.

C: The Δluminance is 2.0% or more and less than 5.0%.

D: The Δluminance is 5.0% or more.

(Reflectance Unevenness)

The obtained organic EL display devices were stored for 1,500 hours in a high temperature-high humidity environment at 60° C. and a relative humidity of 90%, and then moisture-conditioned for 20 hours in an environment at 25° C. and a relative humidity of 60%.

Next, the reflectance was measured for each of the following 13 points in total, namely, the center of the diagonal of the display screen and the points on the diagonal separated from the center by 25%, 50% and 75% of the total length between the center and one end of the diagonal. The difference between the maximum reflectance and the minimum reflectance of the measured reflectance values was determined, and the proportion of the difference in relation to the average reflectance 100 for the 13 points was determined as the Δreflectance (%). Then, for each of the organic EL display devices, the reflectance unevenness was evaluated according to the following standards. The measurement of the reflectance was performed by using a spectral colorimeter CM2500d (manufactured by Konica Minolta Sensing, Inc.), wherein the reflectance at a wavelength of 550 nm was measured.

A: The Δreflectance is less than 0.3%.

B: The Δreflectance is 0.3% or more and less than 0.5%.

C: The Δreflectance is 0.5% or more and less than 1.0%.

D: The Δreflectance is 1.0% or more.

The evaluation results of Examples 24 to 32 and Comparative Examples 6 and 7 are shown in Table 4.

TABLE 4

| | Display | Circularly Polarizing Plate | | | | | Evaluations | |
|---|---|---|---|---|---|---|---|---|
| | Device | | Glass Film | Adhesive Layer | Polarizer | | Front-Surface | Reflectance |
| | No. | No. | No. | (Composition No.) | No. | λ/4 Plate | Luminance Unevenness | Unevenness |
| Example 24 | 401 | 101a | 1 | 1 | 3 | Pure-Ace | B | C |
| Example 25 | 402 | 102a | 1 | 2 | 1 | WR | B | B |
| Example 26 | 403 | 103a | 2 | 1 | 1 | | A | B |
| Example 27 | 404 | 104a | 1 | 1 | 1 | | A | A |
| Example 28 | 405 | 105a | 3 | 1 | 1 | | B | A |
| Example 29 | 406 | 106a | 4 | 1 | 1 | | B | B |
| Example 30 | 407 | 107a | 3 | 3 | 1 | | A | A |
| Example 31 | 408 | 108a | 1 | 1 | 1 | | B | B |
| Example 32 | 409 | 109a | 3 | 1 | 1 | | B | B |
| Comparative | 410 | 112a | 1 | 6 | 1 | | D | D |
| Example 6 | | | | | | | | |
| Comparative | 411 | 113a | 1 | 1 | 2 | | D | D |
| Example 7 | | | | | | | | |

As can be seen from Table 4, as compared to the display devices of Comparative Examples 6 and 7, the display devices of Examples 24 to 32 were lower in the front-surface luminance unevenness and the reflectance unevenness, even after the storage in an environment at a high temperature and a high humidity for a long period of time.

The present application claims the priority based on Japanese Patent Application No. 2012-117639 filed on May 23, 2012. The contents described in the specification and the drawings of the application concerned are all incorporated herein by reference.

### INDUSTRIAL APPLICABILITY

According to the present invention, it is possible to provide a polarizing plate capable of limiting deformation or warping thereof when the polarizing plate or a display device including the polarizing plate is stored at a high temperature and a high humidity, while the display device is being sufficiently reduced in thickness, and to provide a method of manufacturing the polarizing plate.

### REFERENCE SIGNS LIST

10 Polarizing plate
12 Polarizer
14, 64, 84, 124 Glass film
16, 66, 86, 126 Adhesive layer formed of cured product of actinic radiation-curable composition
20 Liquid crystal display device
40 Liquid crystal cell
60 First polarizing plate
62 First polarizer
68 Protective film (F2)
80 Second polarizing plate
82 Second polarizer
88 Protective film (F3)
90 Backlight
100 Organic EL display device
112 Light reflection electrode
114 Light emitting layer
116 Transparent electrode layer
118 Transparent substrate
120 Circularly polarizing plate
122 Polarizer (linearly polarizing film)
128 λ/4 Plate

1. A polarizing plate comprising:
a polarizer containing a dichroic dye, the polarizing having a thickness of 0.5 to 10 μm;
a glass film; and
an adhesive layer disposed between the polarizer and the glass film, the adhesive layer being formed of a cured product of an actinic radiation-curable composition.

2. The polarizing plate according to claim 1, wherein the dichroic dye is localized on one side of the polarizer.

3. The polarizing plate according to claim 1, wherein the actinic radiation-curable composition comprises an ultraviolet absorber.

4. The polarizing plate according to claim 1, wherein an optical transmittance at a wavelength of 380 nm of the adhesive layer formed of the cured product of the actinic radiation-curable composition is 5% or more and 40% or less.

5. The polarizing plate according to claim 2, wherein the adhesive layer formed of the cured product of the actinic radiation-curable composition is disposed on a surface of the polarizer where the dichroic dye is localized.

6. The polarizing plate according to claim 1, wherein a thickness of the glass film is 1 to 200 μm.

7. The polarizing plate according to claim 1, wherein when a length of the polarizing plate in a width direction is denoted by W, and a length of the polarizing plate in a direction perpendicular to the width direction is denoted by L, L/W is 10 to 3,000, and
the polarizing plate is wound in a roll shape in a direction perpendicular to the width direction of the polarizing plate.

8. A method of manufacturing the polarizing plate according to claim 1, comprising:
A) obtaining a polarizer;
B) laminating the polarizer on a glass film through the intermediary of a layer of an actinic radiation-curable composition, and
C) curing the actinic radiation-curable composition by irradiating the layer of the actinic radiation-curable composition with an actinic radiation,
wherein the step A) of obtaining a polarizer comprises:
1) obtaining a laminate composed of a base material film and a polyvinyl alcohol resin layer by applying a solution containing a polyvinyl alcohol resin on the base material film;
2) uniaxially stretching the laminate; and
3) dyeing the polyvinyl alcohol resin layer of the laminate with a dichroic dye or dyeing the polyvinyl alcohol resin layer after the uniaxial stretching with the dichroic dye.

9. The method of manufacturing a polarizing plate according to claim 8, wherein in the step C), the layer of the actinic radiation-curable composition is irradiated with the actinic radiation through the glass film.

10. The method of manufacturing a polarizing plate according to claim 8, wherein in the step B), the polarizer unwound from a rolled body of the polarizer and the glass film unwound from a rolled body of the glass film are laminated on each other through the intermediary of the actinic radiation-curable composition layer.

11. The method of manufacturing a polarizing plate according to claim 8, wherein in the step 3), the polyvinyl alcohol resin layer of the laminate after the uniaxial stretching is dyed with the dichroic dye.

12. The method of manufacturing a polarizing plate according to claim 8, further comprising, after the step C), removing the base material film laminated on the polarizer.

13. An image display device comprising the polarizing plate according to claim 1.
